(19) United States
(12) Patent Application Publication
(10) Pub. No.: US 2024/0386481 A1
(43) Pub. Date: Nov. 21, 2024

(54) Method and System for Trading Merchandise and Services by Multi-party Matching

(71) Applicant: Quan Xiao, Wellesley, MA (US)

(72) Inventor: Quan Xiao, Wellesley, MA (US)

(21) Appl. No.: 18/319,477

(22) Filed: May 18, 2023

(51) Int. Cl. G06Q 30/08; G06Q 10/0833; G06Q 10/0835; G06Q 20/12; G06Q 30/0201; G06Q 30/0282; G06Q 30/0601; G06Q 40/04

(52) U.S. Cl. CPC G06Q 30/08; G06Q 10/0833; G06Q 10/08355; G06Q 20/12; G06Q 30/0201; G06Q 30/0282; G06Q 30/0611; G06Q 30/0633; G06Q 40/04

(57) ABSTRACT

The invention relates to online trading of merchandise and services between multiple parties. Both sellers and buyers can list new items (merchandise or service) and place asking/bidding price on any items on the marketplace for trade. Shipping carriers can also list new shipping services and place Freight Bid on any shipping services on the marketplace. A Spread/Gap price is calculated by formula including fees from all stakeholders, including taxes, and platform's service fees. It is then used to match deal candidates and set the deals' execution orders. Users interact with WYSIWYG interface to review current and historical market data analysis. Users can place market orders to get the best available deal on the current market, or place Limit Order, Stop Orders, or use other order types used in trading of stocks, options and futures. New financial instruments or derivatives can be created and traded in the marketplace.

### CROSS-REFERENCE TO RELATED PATENTS

(1) This application is entitled to the benefit of Provisional Patent Application Ser. No. 60/708,755, originally filed on Aug. 17, 2005.
(2) This application is entitled to the benefit of U.S. Pat. No. 7,729,977, on Jun. 1, 2010.

### BACKGROUND OF THE INVENTION

The present system and method relate to online trading of merchandise and services. There are many ways people can buy and sell stuff. Like auction system (eBay), reverse auction system (Priceline), online marketplaces (Amazon, Alibaba, Swap) and Classified Ad (Facebook, Craigslist). In traditional auctions, buyers bid higher prices to win the listed item, while in reverse auctions, sellers bid lower prices to win the buyer's contract. Online marketplace or social media allows buyers and sellers to connect directly and make transactions.

People also trade stocks, bonds, options, and other financial instruments on the stock market. However, unlike stock market transactions where no shipping is required and matching deals only require comparing the seller's asking price and the buyer's bidding price, trading common merchandise involves additional factors. Not only do buyers and sellers participate in the transaction, but a carrier is also needed to ship the product from the seller to the buyer once a deal is made. Deal matching cannot be determined solely by comparing the seller's asking price and the buyer's bidding price, as additional shipping costs can impact whether a deal is feasible. Other factors such as sales tax, handling fees, discounts, and fees paid to brokers or to the platform can further complicate trading common merchandise.

In e-commerce marketplaces, finding a carrier to ship the merchandise and finalizing the transaction is typically the responsibility of the seller. Shipping and handling costs, along with sale taxes, are not calculated and displayed until the checkout process. As a result of these miscellaneous costs, the asking price is not the final amount the seller can actually receive in the end. Similarly, the seller needs to pay for shipping and handling costs to the carrier and, sometimes, additional fees charged by the marketplace. So the bidding price is not the final cost that buyer actually pays in the end, as sales tax may be added during the checkout process.

Similar issues also exist in commodity trading systems, where the parties involved include buyers, sellers, brokers, and clearinghouses. However, carriers are not considered as direct parties and do not participate in deal matching. Their role is limited only to fulfilling the physical transportation of goods. Like e-commerce marketplaces, shipping arrangements are generally made separately outside the trading platform and process. The buyer or seller is responsible for coordinating and managing the shipping carrier's services after a deal is matched and closed.

In summary, traditional marketplaces face several challenges. First, neither sellers nor buyers can know the exact final payment sellers will receive or the final cost buyers will pay until the entire process is completed at checkout. Second, there are multiple lengthy steps involved, such as selecting a counterparty, adding products to the cart, and checking out, where users can finally review shipping, handling, and tax information. Third, users, being human, cannot browse and compare all offers on the marketplace filled with overwhelming information, and the deal they pick might not be the best one available. Lastly, there are potential risks related to fraud, quality, and privacy issues.

It will be great if we have a trading system that will address all of those issues, providing a simple, efficient and secure way for a customer to trade any merchandise and service, even when carriers are needed in the end. My invention disclosed herein resolves all above issues in both e-Commerce marketplace and the Commodity Trading system with currently available technologies.

### SUMMARY OF THE INVENTION

This current invention provides a new real real-time trading platform. It is not an ‘auction’ platform nor a “reverse auction” platform or regular shopping e-marketplace. Merchandise and Service are traded in this system among ALL involved parties. Parties can see their portion of value distribution in real time and know the exact amount he/she will receive or pay from the very beginning. Parties can modify or cancel their offers any time before a deal is matched. Carriers are actively involved in deal matching and make trading more efficient. Parties can place market orders, set criteria for placing limit orders and stop orders for trading regular merchandise and services. Parties can even trade options and futures of a regular merchandise's derivatives.

### BRIEF DESCRIPTION OF DRAWINGS

FIG. 1. Illustration of marketplace where an item is traded between four buyers and five sellers.

FIG. 2. Twenty Combinations between four Buyer and five Sellers.

FIG. 3. Three Carriers compete on twelve distinct routes and their freight tariff table.

FIG. 4. Sixty Deal Candidates List with Gap/Spread.

FIG. 5. Sixty Deal Candidates list are sorted by Gap/Spread.

FIG. 6. Matching and making the first deal according to Rank of Gap.

FIG. 7. More deals are made according to the Rank of Gap.

FIG. 8. A marketplace where four buyers and five sellers, and their offer quantity is more than one. List of all the 20 Buyer/Seller Combinations at the bottom.

FIG. 9. When three carriers are introduced to the 20 Buyer-Seller Combination, a list of total 60 Deal Candidates are generated, then Gap/Spread are calculated for each of them.

FIG. 10. Deal Candidate List are sorted by Gap/Spread in descending order.

FIG. 11. Deal Matching started from top ranked Deal Candidates with the largest Gap/Spread

FIG. 12. Deal matching continues to next ranked after the first Deal Candidate has made a deal.

FIG. 13. All Deal Candidates with positive Gap value are matched, and the remaining ones with a negative Spread will remain in the marketplace waiting for market condition changes.

FIG. 14. Market Price to Buyer.

FIG. 15. Market Price to Seller.

FIG. 16. Market Price to Carrier when route-package-shipping service information is ignored and sub-markets are mixed and combined.

FIG. 17. Market Price to Carrier when carrier compete on all submarkets of all routes and shipping services levels.

FIG. 18. Illustration of the trade platform's interface to Buyer.

FIG. 19. Illustration Deal Candidates on the marketplace, and the different prospect of views of the marketplace by Buyer, Seller and Carrier.

FIG. 20. Illustration of the trade platform's interface to Seller.

FIG. 21. Illustration of the trade platform's interface to Carrier.

FIG. 22. Illustration of pre-matching of item, shipping service, counter party, etc. And a 4-set Venn graph shows how to pre-match Buyer-Seller-Carrier consortium to get candidates list then calculate Gap/Spread and rank.

### DETAILED DESCRIPTION OF THE DRAWINGS

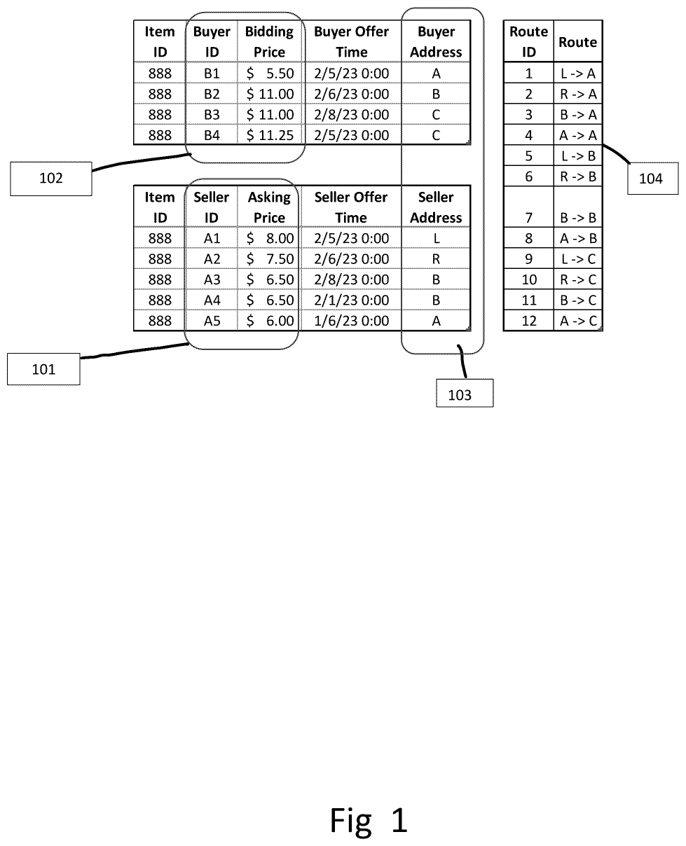

FIG. 1. Illustration of an example of a product being traded on the marketplace. For Item #888, there are a total of 5 sellers A1-A5. Each one sells one of the item #888 with their asking prices ranging from $8 to $6 {101}. At the same time, there are a total of 4 buyers whose bidding prices range from $5.50 to $11.25 and for buying Item #888 {102}. Please also note that the 4 buyers are in 3 different locations (A, B and C), and the 5 sellers are in 4 different locations (A, B, R and L) {103}. As a result, there is a total of 4×3 equals 12 different possible routes needed for shipping the product from seller to buyers. The list of all possible routes is shown on the right side {104}.

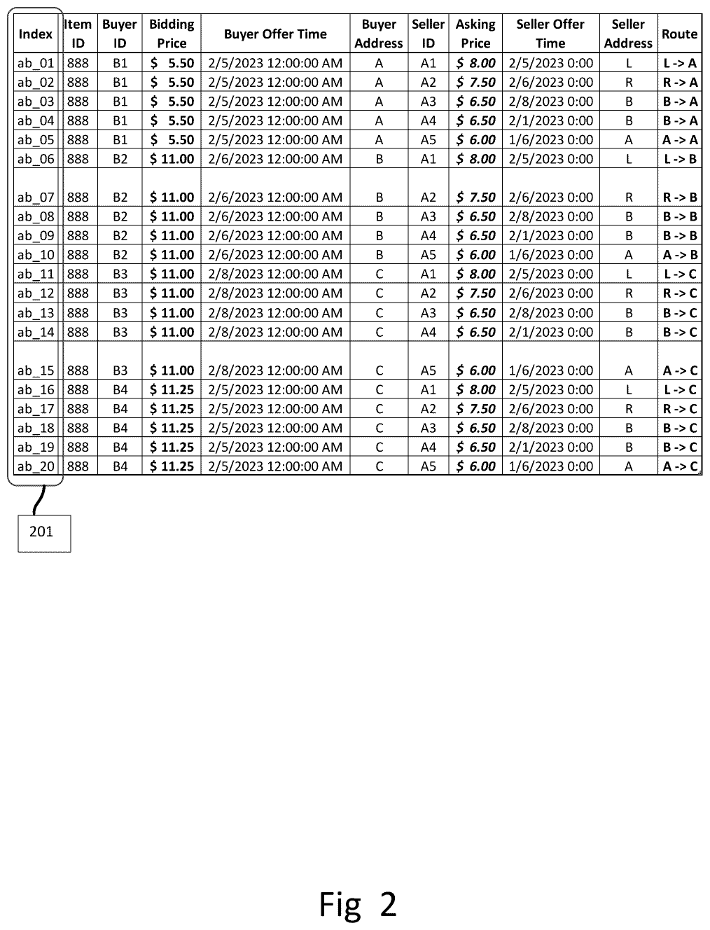

FIG. 2. presents a table illustrating all 20 possible combinations of the four buyers and five sellers. Each row represents a unique combination pair between a seller's asking price and a buyer's bidding price. An index in the format “ab_##” {201} is assigned to identify each Buyer-Seller Combination (Asking-Bidding Pair). The table includes the Seller's ID, the Asking Price, the Buyer's ID, the Bidding Price and Shipping Route information.

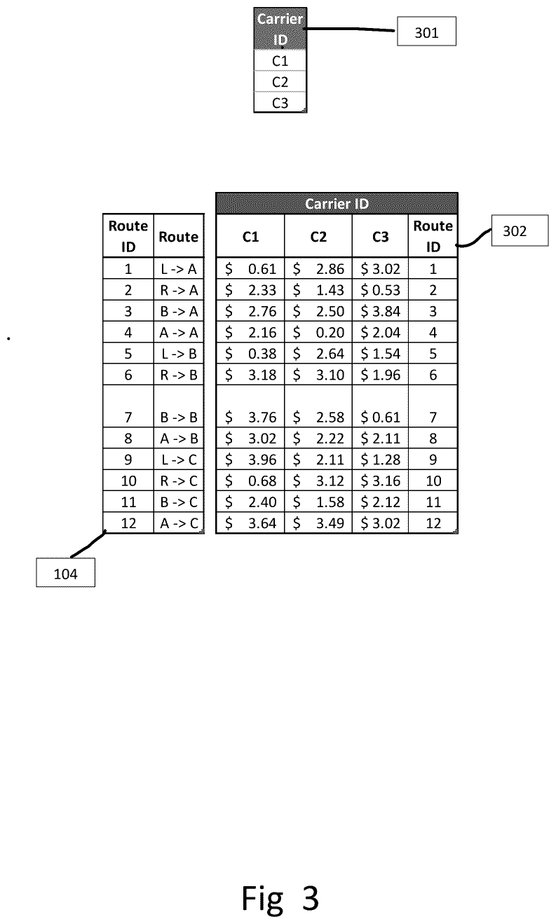

FIG. 3. This illustration presents a sample scenario with three distinct shipping carriers {301} in the market, all of which want to provide services for shipping item #888. A tariff lookup table {302} is provided, displaying the shipping rates from each carrier across all the 12 different routes {104}. This allows for easy comparison of the carriers' tariffs for different routes.

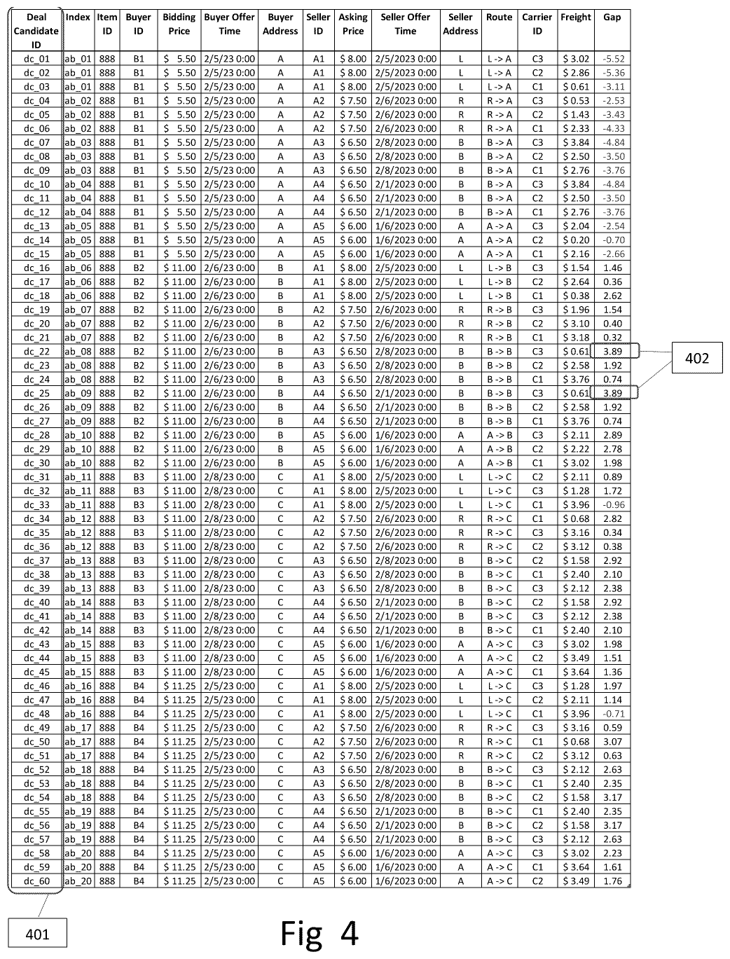

FIG. 4. This illustration showcases the shipping cost tariffs from the three carriers have been incorporated into the 20 Asking-Bidding pair based on the associated shipping routes. For each Asking-Bidding pair, the Gap Price/Spread is calculated by subtracting the sum of the asking price and shipping cost from the bidding price. With three carriers offering shipping services for each of the 20 Asking-Bidding pairs, a total of 60 deal candidates are generated. Each deal candidate line is assigned a unique Deal Candidate ID {401} in the format of “dc_##” for easy reference. {402} shows dc_22 and dc_25 have the same Gap Price values.

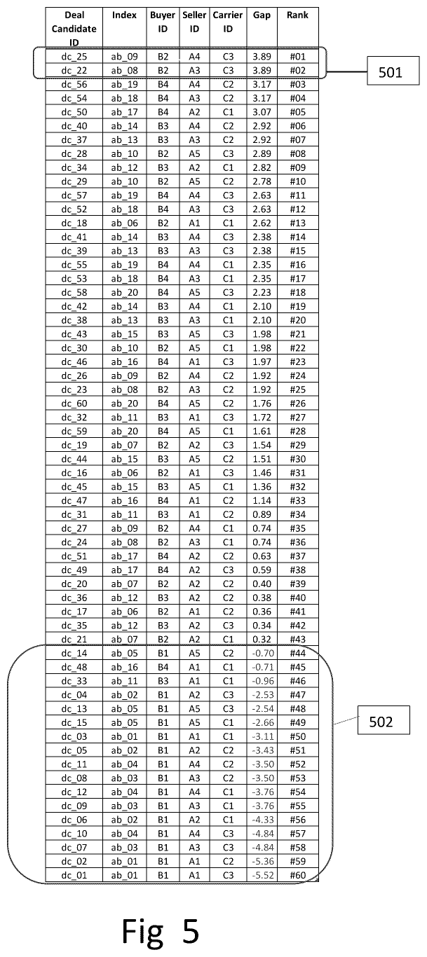

FIG. 5. The total 60 Deal Candidate lines have been sorted by Gap price/Spread in descending order and then ranked from 1 to 60. Ranking is based first on the Gap Prices/Spread, and then on other types of criteria such as the time of the offers being made if the lines have same Gap Price {501}. It is obvious that Deal Candidate lines with negative Gap prices {502} will not make any matched deal at current market condition. To simplify the table, the parties' detailed offer prices are also removed, only the Buyer ID, Seller ID, Carrier ID, Gap prices and the Rank columns are shown.

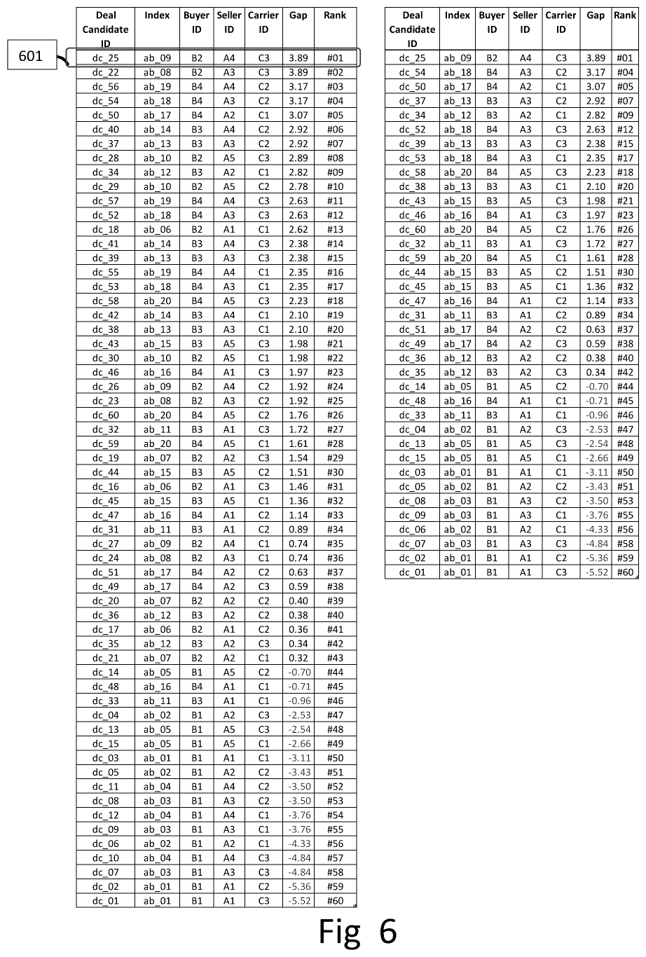

FIG. 6. The platform utilizes an Electronic Offer Matching Program to facilitate deal-making between parties. This program processes the deal candidates in order of their ranks, prioritizing the deals on the top with higher ranks for matching first. By systematically working through the ranked deal candidates from top (dc_25, rank #1) to bottom (dc_01, rank #60) of the Deal Candidate List, the program ensures that the most favorable deals are matched before considering any lower-ranked alternatives. Here, the first row on top (dc_25, rank #1) {601} is the deal to be executed first, and all other rows under it are on waiting list until dc_25 is executed. The dc_25 is a matched deal between Buyer B2 and Seller A4 via Carrier C3, so B2 and A4 no longer need any other deal when the dc_25 deal has been made. This results in all lower ranked deal candidates on the waiting list that involve either B2 (like dc_22, rank #2, etc.) or A4 (like dc_56, rank #3; dc_14, rank #6, etc.) will be removed from the queue. Carriers usually do not have their Quantity limit capped so other lower ranked deals involving C3 are not affected in this example. After the first deal (dc_25, rank #1) is made, the table on the left is transformed into the table on the right where unqualified Deal Candidates have been removed. The next deal candidate under dc_25 is now dc_54.

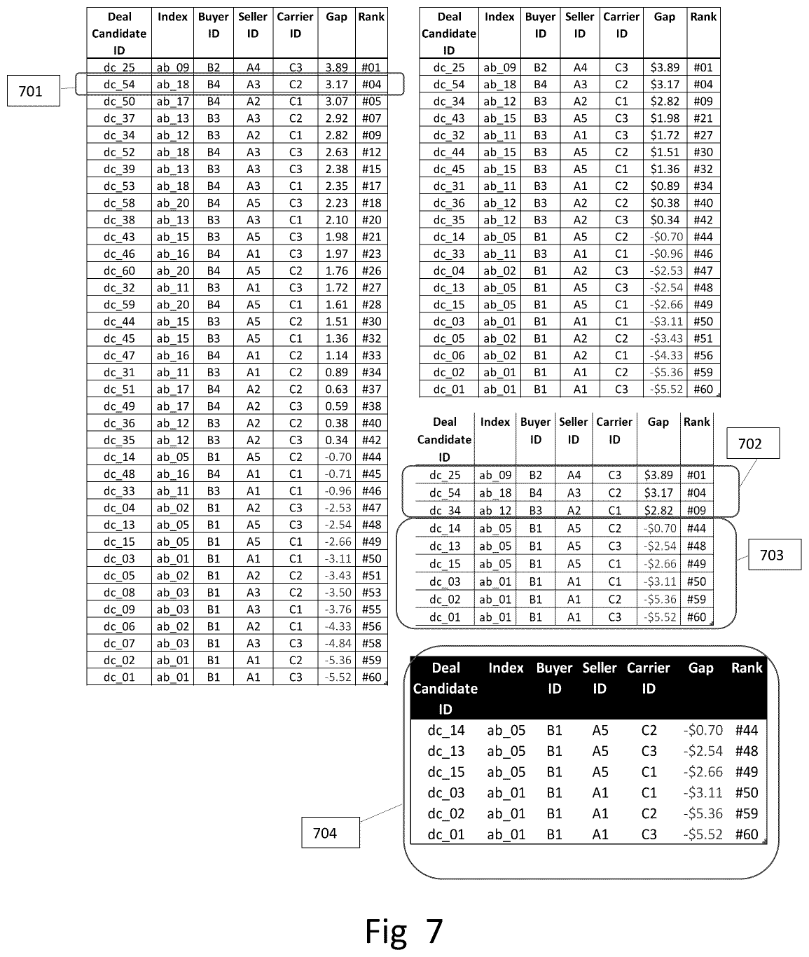

FIG. 7. The matching process continues after the top ranked dc_25 deal is made. It now moves to the next deal candidates remain on the waiting list. The 2nd row is dc_54, rank #4 (dc_22 involves B2 and dc_56 involves A4 have been removed from the waiting list when dc_25 is executed at previous step). Dc_54 is a matched deal between B4 and A3 {701}, so after the dc_54 deal is executed, all deal candidate lines that involve either B4 (like dc_50, rank #5; dc_52, rank 12, etc.) or A3 (like dc_37, rank #7; dc_52, rank 12, etc.) will be removed from the waiting list. The matching process continues until no line with positive Gap Price is left on the waiting list. After all matched deals {702} have been executed, only those Deal Candidates whose spread is negative will remain on the marketplace. In our example, it will be dc_14 originally ranked at #44 through dc_01 originally ranked at #60 {703}. The marketplace now has one Buyer B1, two sellers A5 and A1, and 3 Carriers, consists of total 6 Deal Candidates with the max Spread as $0.70 {704}.

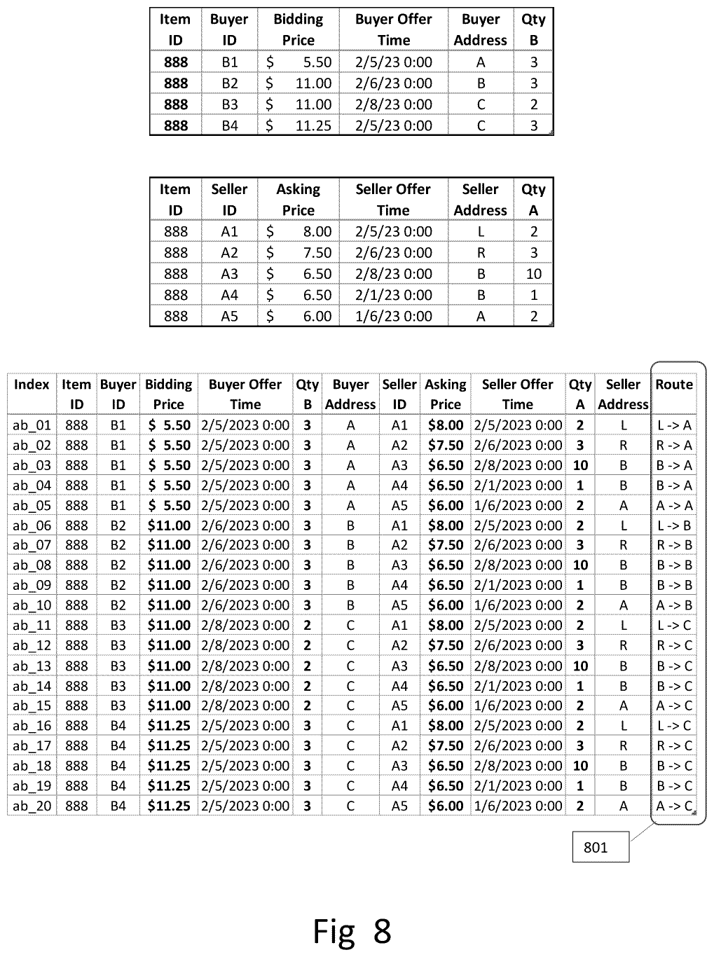

FIG. 8. presents a table illustrating all 20 possible combinations of the four buyers and five sellers, and the quantity of their offers are larger than 1. Each row represents a unique combination pair between a seller's asking price and a buyer's bidding price, together with the quantities Buyer and Seller want to trade. To easily identify these pairs, an index in the format “ab_##” is assigned to each Buyer-Seller combination (Asking-Bidding pair). The table includes the Seller's ID, the Asking Price, the Quantity the Seller has for sale, the Buyer's ID, the Bidding Price, the Quantity the Buyer wants to buy and Shipping Route {801} from sellers' locations to buyers' locations.

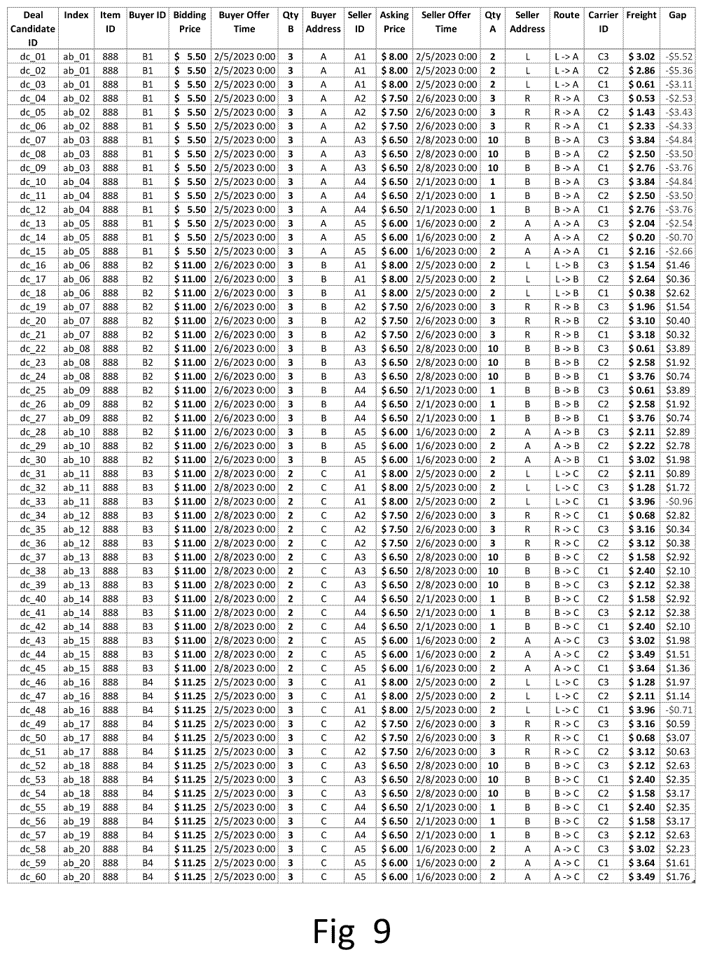

FIG. 9. This illustration is after the shipping cost tariffs from the three carriers are incorporated into the 20 Asking-Bidding pair based on the associated shipping routes. With three carriers offering shipping service for each of the 20 Asking-Bidding pairs, a total of 60 deal candidates are generated. Each deal candidate line is assigned a unique Deal Candidate ID in the format of “dc_##” for easy reference. For each deal candidate, the Gap Price/Spread is then calculated by subtracting the sum of the asking price and shipping freight bid from the bidding price: Gap=Bidding Price−Asking Price−Freight Bid

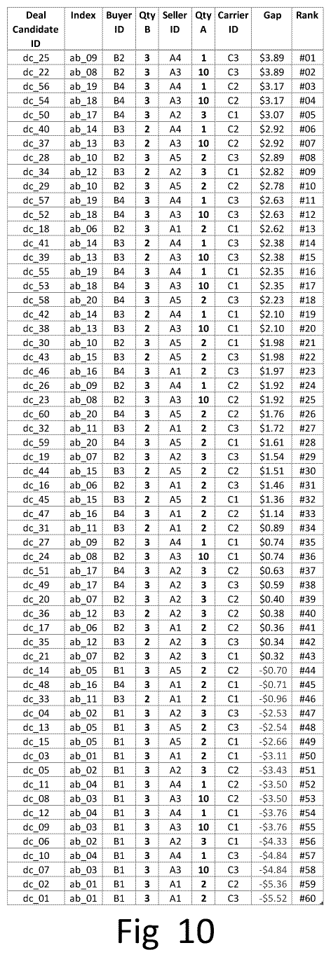

FIG. 10. All Deal Candidate lines are then sorted by Gap price in descending order and then ranked, from #1 to #60 in this example. To simplify the table, the parties' detailed offer price is removed, only the Buyer ID, Seller ID, Carrier ID, Quantity for Sale, Quantity to Buy, the Gap/Spread and the Rank are kept.

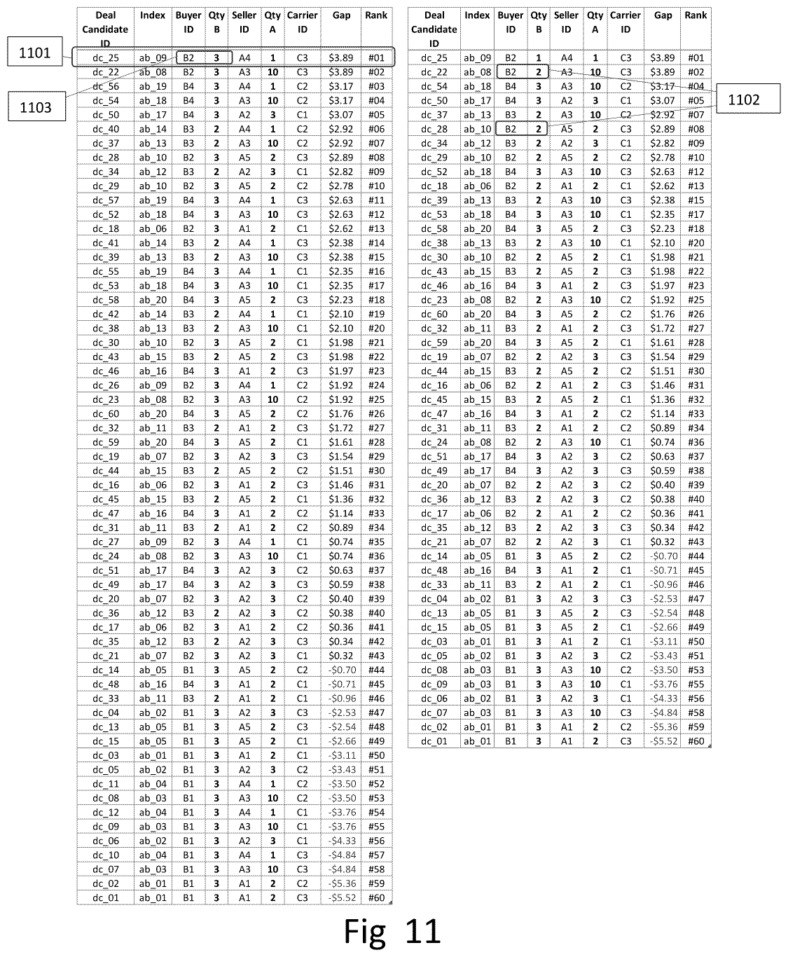

FIG. 11. The platform utilizes an Electronic Offer Matching Program to facilitate deal-making between parties. This program processes the deal candidates in order of their ranks, prioritizing deals on top with higher rank for matching first. By systematically working through the ranked deal candidates from top to bottom, the program ensures that the most favorable deals are matched before considering lower-ranked alternatives. Here, the first row on top (dc_25, rank #1) is the deal to be executed first, and all other rows under it are on the waiting list with lower rank. The dc_25 is a matched deal between Buyer B2 and Seller A4 via Carrier C3, where B2 needs to buy total 3 and A4 can only offer 1 {1101}. As a result, when the dc_25 deal has been executed, B2 still need to buy 2 more while A4 no longer needs any other deal. This results in all lower ranked deal candidates on the waiting list that involves A4 (like dc_56, rank #3; dc_40, rank #6, etc.) will be removed from the waiting list queue. For those lower ranked Deal Candidates on waiting list that involves B2 (like dc_22, rank #2; dc_08, rank #8, etc.), the corresponding Quantity needed by B2 will be reduced from 3 {1103} to 2 {1102}, as B2 just got one item from A4 in the top ranked matched dc_25 Deal. Please note that dc_22 still remains on the waiting list because B2 needs to buy 2 more to reach the total number of 3 that B2 wants to buy in total. Carrier usually does not have a Quantity limit capped so lower ranked deals involved C3 are not affected in this example. After the first deal (dc_25, rank #1) is executed, the table on the left is transformed into the table on the right.

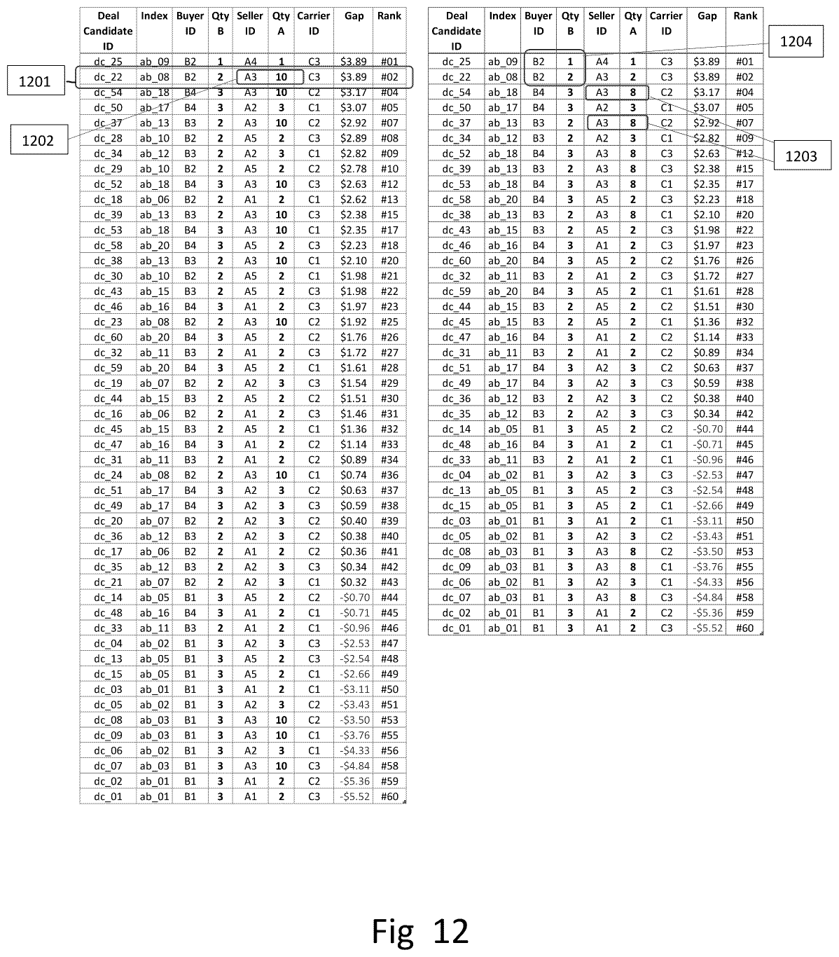

FIG. 12. The matching process continues after the top ranked dc_25 deal is made. It now moves to the next deal candidates remain on the waiting list. The 2nd row is dc_22, rank #2 {1201}. It is a matched deal between B2 and A3 via C3, where B2 only needs to buy 2 more and A3 can offer 10 in total. When the dc_22 deal has been made, A3 still have 8 more left to sell while B2 has already got all 3 items {1204} in total. As a result, B2 no longer needs any other deal. This results in all lower ranked deal candidates on the waiting list that involve B2 (like dc_28, rank #8; dc_29, rank #10, etc.) will be removed. For all lower ranked Deal Candidates on waiting list that involve A3 (like dc_54, rank #4; dc_37, rank #7, etc.), the corresponding Quantity for sale will be reduced from 10 {1202} to 8 {1203}, as A3 just sold 2 to B2 in the matched dc_22 Deal and only have 8 left. After the 2nd deal (dc_22, rank #2) is made, the table on the left is transformed into the table on the right.

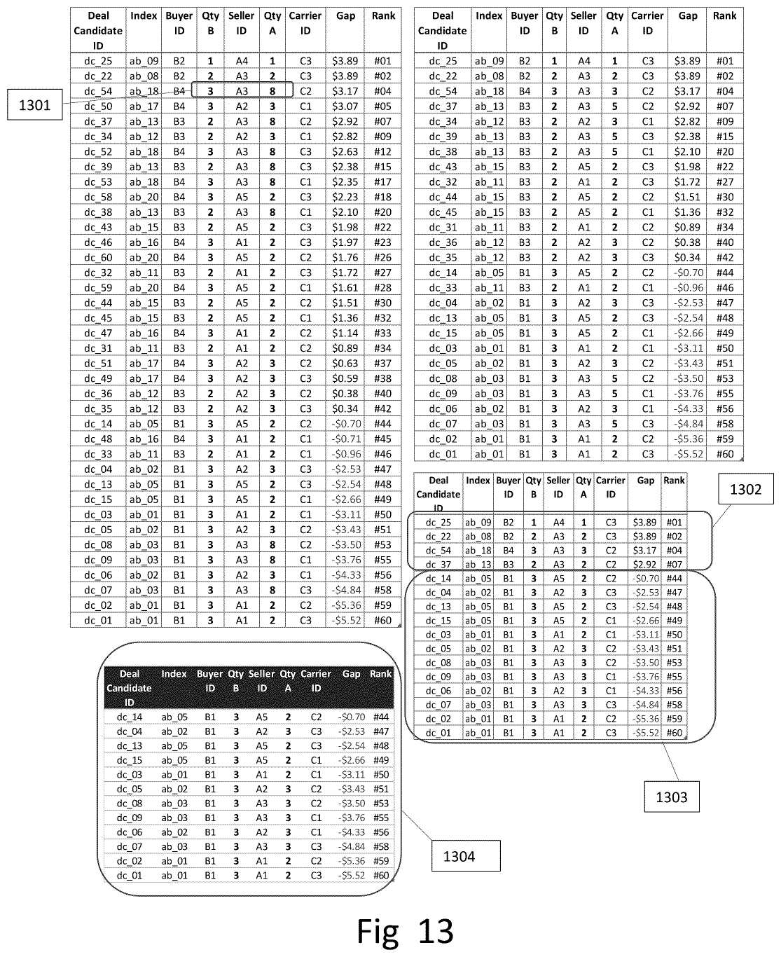

FIG. 13. The matching process continues after the 2nd ranked dc_22 deal is made. It now moves to the next deal candidates remain on the waiting list. The 3rd row (dc_54, rank #4.) is a matched deal between B4 and A3 via C2, where B4 needs to buy 3 and A3 can offer 8 in total {1301}. When the dc_54 deal has been made, A3 still have 5 more to sell while B4 no longer need any other deal. This results in all lower ranked Deal Candidates on the waiting list that involve B4 (like dc_50, rank #5; dc_52, rank #12, etc.) will be removed from queue. For those lower ranked Deal Candidates on waiting list that involve A3 (like dc_37, rank #7; dc_39, rank #15, etc.), the corresponding Quantity for sale will be reduced from 8 to 5, as A3 just sold 3 to B4 in the matched dc_54 Deal. The matching process continues until no Deal Candidate line with positive Gap price is left on the waiting list. After all matched deals {1302} have been executed, only those Deal Candidates whose Spread are negative will remain on the marketplace. In our example, it will be dc_14 originally ranked at #44 through dc_01 originally ranked at #60 {1303}. The marketplace has one Buyer B1, four sellers A5, A2, A1 and A3, and 3 Carriers, and consists of a total of 12 Deal Candidates with the max Spread of $0.70 {1304, 1901}.

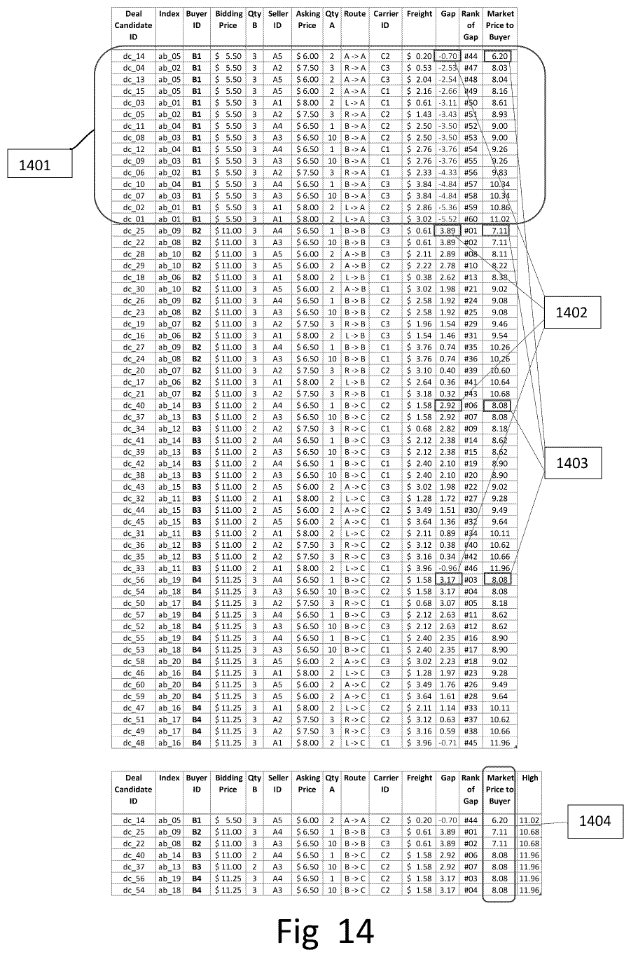

FIG. 14. To any buyer, the total cost he needs to pay equals to the Seller's asking price plus the corresponding Carriers' freight bid from corresponding route. For example, Buyer B1's deal list is shown {1401}. The market price is the best deal a buyer can get on the marketplace, which means the best among all Seller/Carrier combinations that has the highest Gap/Spread {1402}. This combination also offers Buyer the lowest total cost (For Buyers, Market Price will be the lowest value obtained from iterating over all Seller-Carrier pairs, where the value for each pair is calculated as the sum of the Seller's asking price and the Carrier's freight bid) {1403, 1404}. It tells Buyer B1 needs to offer at least $6.20 instead of $5.50 to meet the lowest offer on the marketplace; it also means if B1 buys the item at the current market price, the cost will be $0.70 more than what B1 currently offered, and B1 can get 2 items from Seller A5 at that new price.

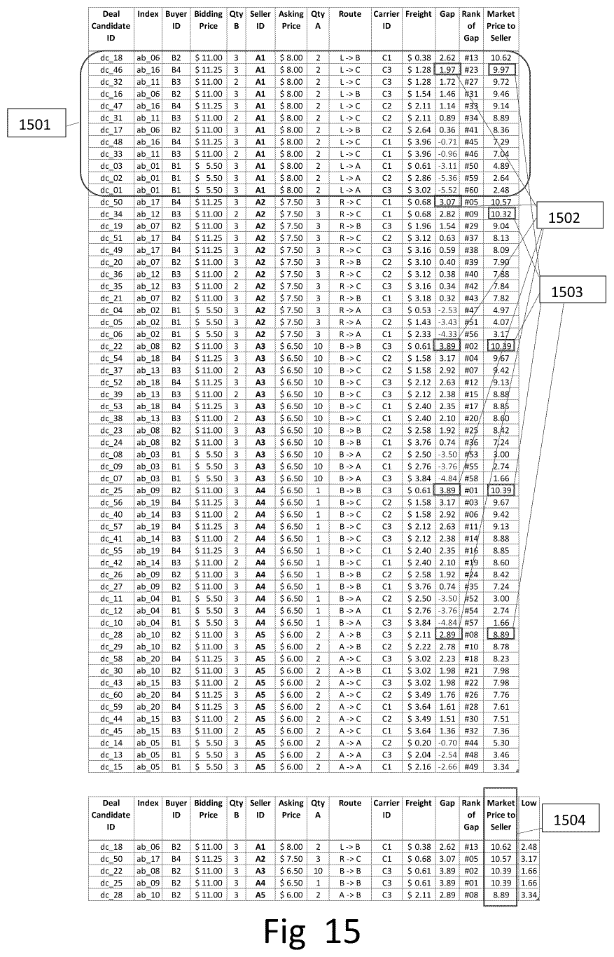

FIG. 15. To any Seller, the total payment he can get equals to the Buyer's bidding price minus the Carrier' freight bid. The Deal Candidate list involving Seller A1 is shown {1501}. The market price is the best deal he can get on the marketplace, which means the best among all Buyer/Carrier combinations that has the highest Gap/Spread {1502}. This combination also offers the highest payment amount to sellers (For the Seller, Market Price will be the highest value obtained from iterating over all Buyer-Carrier pairs, where the value for each pair is calculated as the difference between the Buyer's bidding price and the Carrier's freight bid) {1503, 1504}. It tells Seller A1 can ask for $10.62 instead of only $8.00 and still can meet the highest offer on the marketplace; it also means if A1 sells the item at the current market price, A1 will get paid $2.62 more than what he is currently asking for.

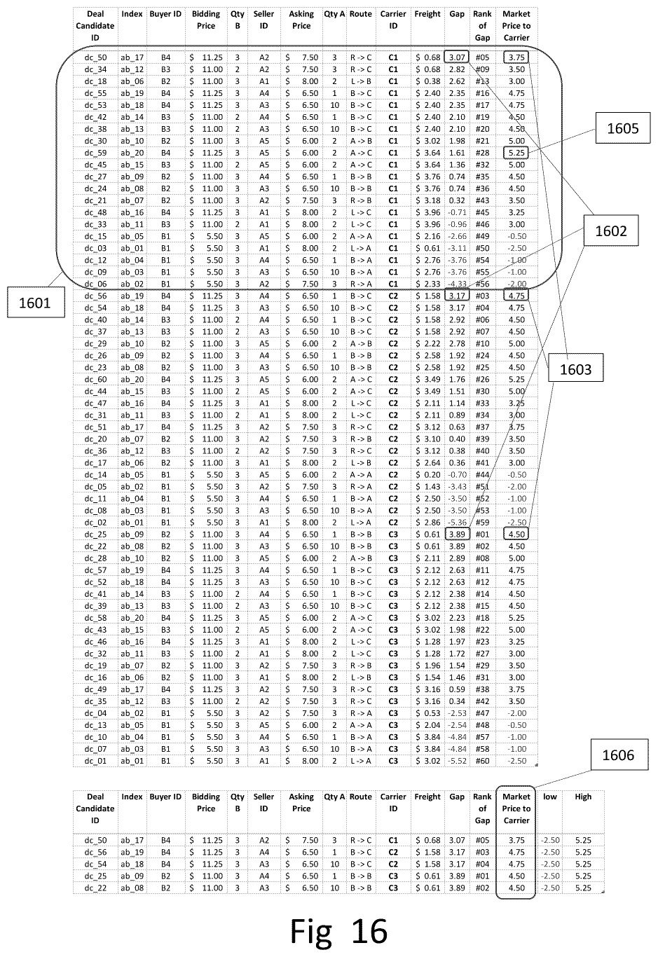

FIG. 16. To any Carrier, he is competing on the shipping services of delivering different packages at different service levels via different routes from Sellers to Buyers. The total payment he can get from a deal transaction equals to the Buyer's Bidding Price minus the Seller's Asking Price. The Deal Candidate list involving Carrier C1 is shown {1601} which contains different routes. The Market Price for the entire marketplace (combines all sub-markets regardless of what routes-package combination) is the best deal the carrier can get on the entire marketplace among all Buyer-Seller (route-package-service) combinations that offers the highest Gap/Spread {1602} and thus has the highest rank. The Buyer-Seller pair combination with the highest Gap/Spread {1602} is not necessarily always where Carrier will get the highest total payment amount (Buyers' bidding price minus Sellers' asking price) {1605}. This is because different routes-package-service level combination will have different costs to the carriers as well. The actual best deal for a carrier is reached when the Gap/Spread is maximum {1602, 1606}. Different from Buyers or Sellers scenario, the different routes-package-service level combinations to carrier are like different items to buyer and seller, where each combination acts like a sub-market that have different costs to the carrier. For example, Carrier C1 can get $5.25 from dc_59 as payment {1605}, which is higher than dc_50′s $3.75 total payment. But Carrier C1's Freight Bid on dc_59 is $3.64 which is much higher than $0.68 on dc_50. In dc_50 where the Gap is $3.07, Carrier C1 can get $3.07 extra above his Freight Bid. The Gap value is only $1.61 on dc_59, even C1 can get total payment of $5.25. dc_59 and dc_50 are from different routes thus belong to different sub-markets. The table {1606} listed the Market Prices to all the carriers where the deals have the biggest gap/highest rank.

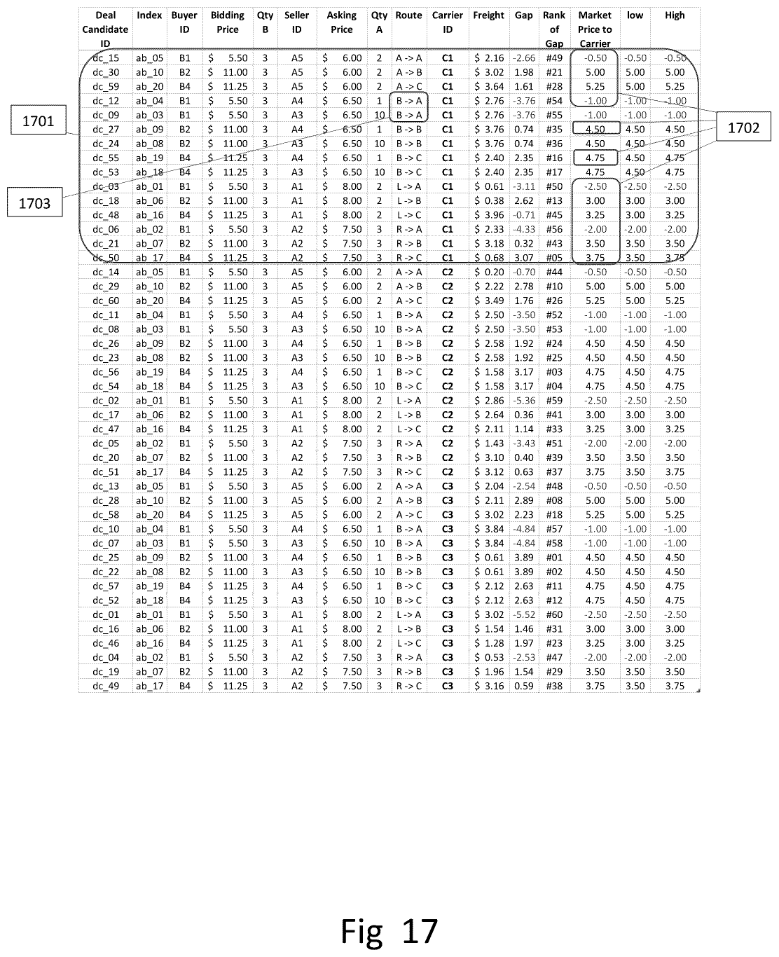

FIG. 17. Carriers usually compete on all the routes on the market instead of just picking the best one route. In this case, the entire marketplace is then divided into many sub-markets each identified by the different route-package-service level (each combination acts to Carrier the same way as an item to Buyer and Seller). There is a Market Price for each of those sub-marketplaces. For Carrier C1, there are a total of 15 Deal candidates across 12 different routes on the entire market {1701}. We only have one package type and service level in the example so each route here represents a sub-market. There is a market price for each of those submarkets, a total of 12 routes will generate a total of 12 market prices {1702} to Carrier C1. Within each submarket (route), only one route-package-service level is involved. For example, dc_12 and dc_09 are on same B->A route {1703}. Market Price to a carrier (MP_{Carrier}) equals to the highest value obtained from iterating over all Buyer-Seller pairs, where the value for each combination is calculated as the difference between the Bidding Price and the Asking Price:

$${MP}_{Carrier} = Max ( Bidding Price - Asking Price ) .$$

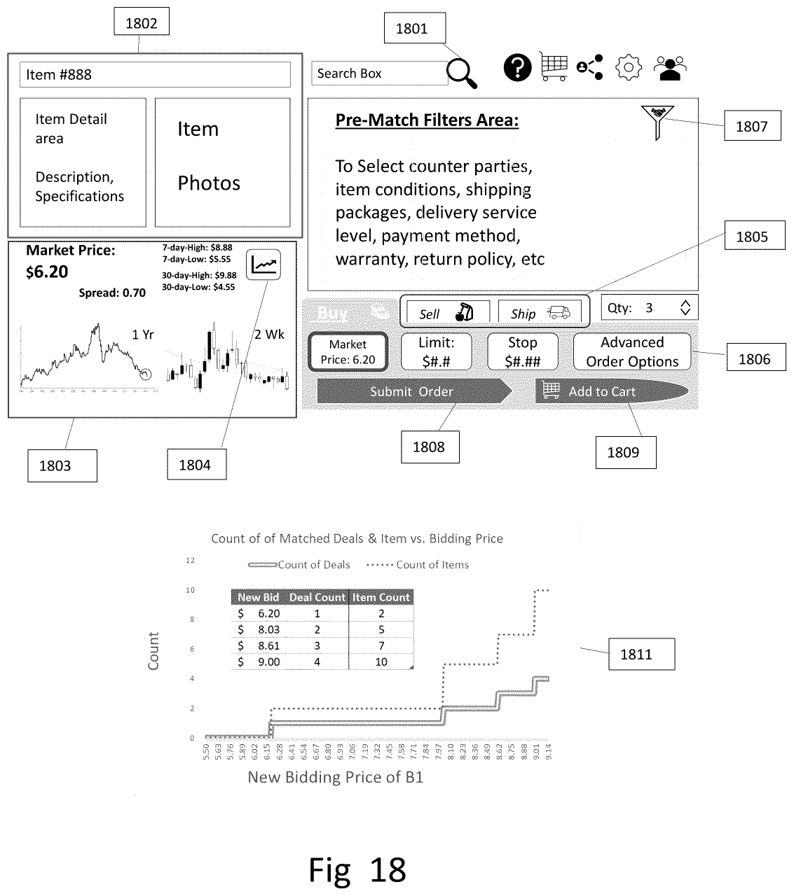

FIG. 18. Illustration of trading platform's interface for a user who acts as Buyer. After the buyer performed an item search using search box {1801}, the item's name, specification and photos are displayed in item information display area {1802}. The real time Market Price and Spread are displayed, along with indicators such as trading volume, historical open and closing price, high price and low price via Bar Chart or Candlestick chart in the market information display area {1803}. Other numerous methods and indicators used in the stock market analysis (both fundamental analysis and technical analysis) can also be used on the trading platform as well, such as Moving Averages, Moving Average Convergence Divergence, Bollinger Bands, Stochastic Oscillator, etc. Buyers can click a button {1804} to access those advanced analytical indicators. The buyer can set some Pre-Match Filters to define what requirement must be met by its Seller or Carrier counterparties, how he wants the item to be packed with, how fast he needs it be delivered, method of payment, pay term, return policy, etc. are all located in Pre-Match Filter Area. The package and service level to be used for shipping the item are important factor to be set by Buyer and Seller and matched with each other before any deals can be made. This also defines the shipping service domain where the carriers will compete on. More Pre-match settings can be adjusted by clicking the filter button {1807}. For detailed setting method please refer to U.S. Pat. No. 7,729,977. After the Buyer set the quantity he wants to buy, he can either place a market order, or limit order or stop order by first selecting the prices settings and then click the Submit Order button {1808} to place the order. Buyers can also add the item to cart {1809} and bid on the entire cart, or do even more advanced order types such as trading options and deliverables. These order options can be set by clicking an Advance Order Option button {1806}. Users can switch their roles from being a Buyer to being a Seller or Carrier by clicking the role tabs {1805} on the same page without logging out. Buyers can assess the potential effects of altering their bidding price, examining how the new price might impact the total number of deals they can make and the total availability of items on the marketplace at the updated price {1811}.

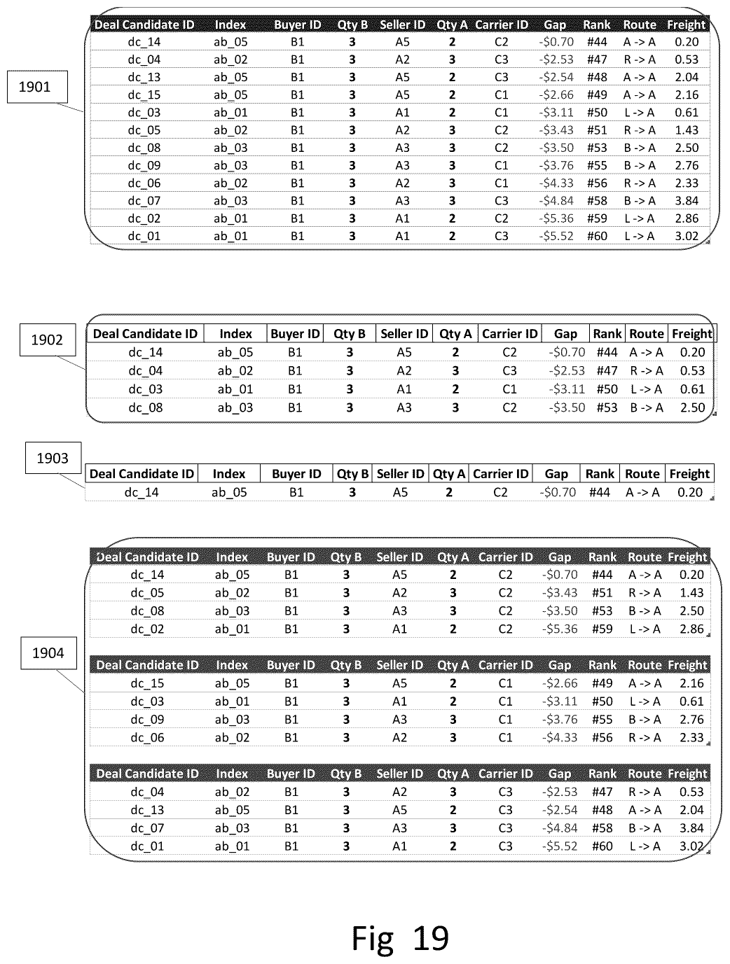

FIG. 19. The marketplace offers varying perspectives for Buyers, Sellers, and Carriers. In a sample Deal Candidate List, represented as {1304, 1901}, the marketplace consists of one Buyer (B1), four Sellers (A1, A2, A3, A5), and three Carriers. From Buyer B1's perspective, the marketplace appears as shown in {1902}, where only the top four deals (highest ranked with the largest spread from each seller) are retained. From each seller's perspective, however, since there is only one buyer in the marketplace, they will only see the single deal from B1 with the highest rank {1903}. Regarding the Carriers, each of them can see four routes requiring shipping services from four sellers to B1 {1904}, with each route corresponding to a Buyer-Seller pair with the highest rank.

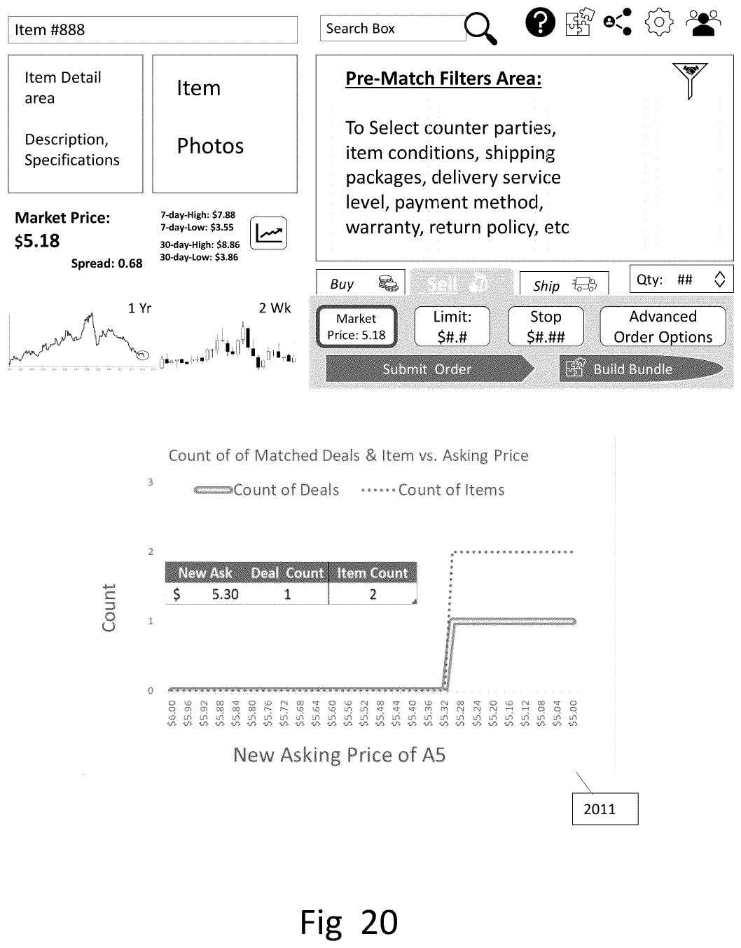

FIG. 20. The Sellers' interface is very similar to that of the Buyers' interface. The seller can evaluate how adjusting their asking price might impact the total number of deals they can make and the overall quantity of items they can potentially sell on the marketplace at the new price level. {2011}. The seller may use the Bundle feature to combine multiple items according to a Bill of Material and then offer the entire bundle besides seller each item separately.

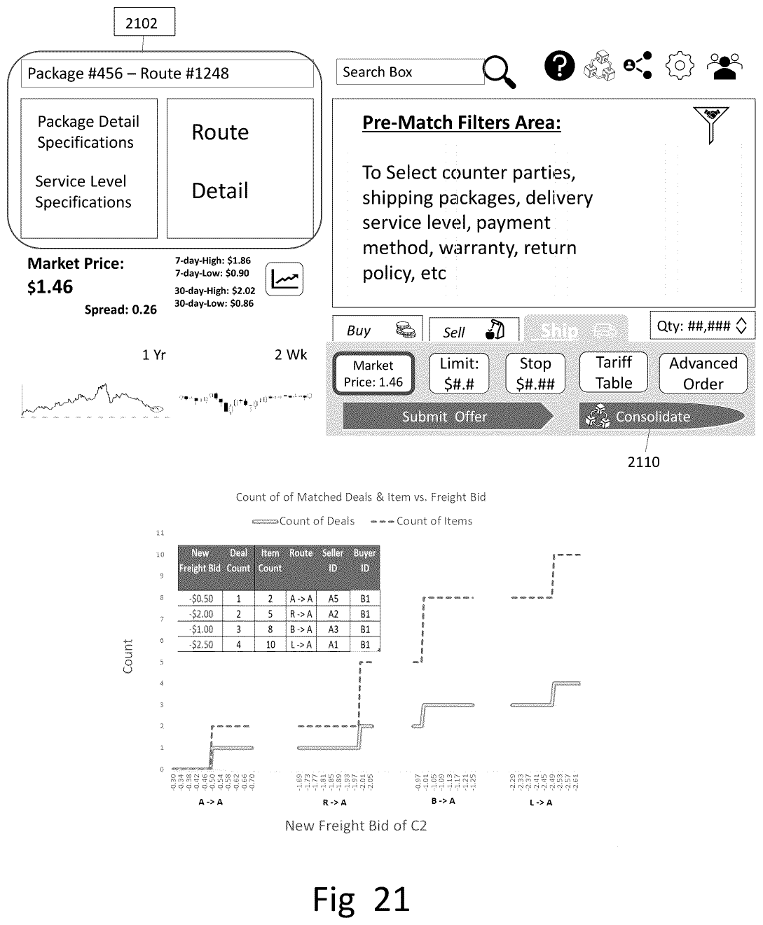

FIG. 21. Carriers' interface however will have area {2102} to display the specific shipping route's details and shipping packaging specification in the Package Info Area. Carriers may consolidate multiple packages on the same route or merge several routes into a multileg shipping service, and only bid on the entire Consolidated service as a whole. For instance, a carrier can create a consolidated route by adding a delivery from location A to location C, followed by another delivery from location C back to location A. The carrier will place a Freight Bid and carry out both shipments together rather than participating in just one. This approach helps the carrier avoid a dry-run. There will also be a feature that allows Carrier to upload, review and update his Freight Tariff Table {2110} where Carrier can set the Freight Bids for all different package type and for all shipping zones in batch.

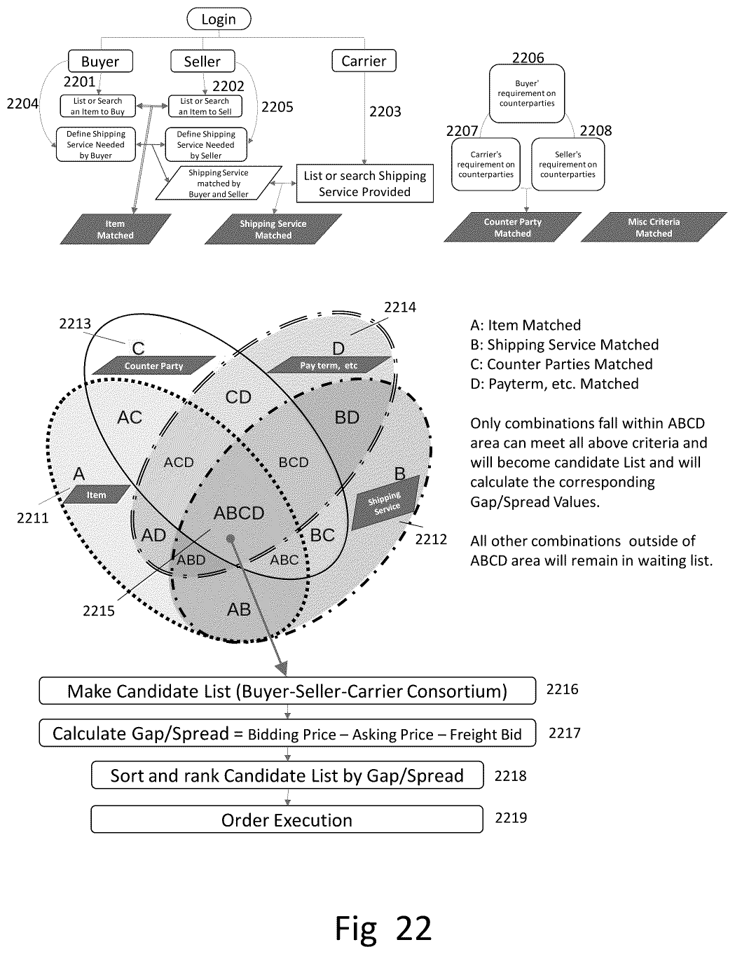

FIG. 22. After a user logged in, he can pick a role as a Buyer, Seller or Carrier to perform different tasks. Depending on the role, the user as a buyer can list an item to buy {2201}, define the shipping service required for that item {2204} and set his requirement for his counterparties (such as seller must have 4+ star rating, and carrier must be 3+ star) {2206} and place a Bid Price. The user as a seller can list an item to sell {2202}, define the shipping service required {2205} and set his requirement for buyers and carriers {2207} and place an Asking Price. The user as a carrier can listing a shipping service to provide {2203}, set his requirement for its counterparties {2208} and place a Freight Bid. He can place bids on any item or service on the market, regardless of if it is listed by himself or by other users. The Venn graph at the bottom represents how to categorize the Buyer-Seller-Carrier Consortium on the marketplace. Each circle represents a category if the consortium has matched item {2211}, matched shipping service {2212}, matched counterparties {2213} and matched misc. criteria {2214}. The area marked with ABCD {2215} is where the consortium has met all the pre-match criteria. Only these consortiums located in area ABCD {2215} will be added to create the Deal Candidate List {2216}, then calculate its Gap/Spread value {2217} and rank, then sort {2218} and execute deals according to the rank order {2219}. Consortium falls outside of ABCD means they failed to meet all the pre-match criteria thus there is no way to make any deals, and they will be kept in a waiting list.

### OBJECT OF THE INVENTION

The current invention provided a new multiparty trading system designed to facilitate the buying and selling of merchandise and services in an efficient and transparent manner. The new trading system not only includes Buyer and Sellers, but also gives other stakeholders like the shipping carrier the same opportunity to place real time Freight Bid and be involved more actively in the deal matching process.

The new trading system provides to Parties of the trade a What You See Is What You Get (WYSIWYG) interface, which provides a better user experience. Buyer can see the final price to pay, Seller and Carrier can see the final payment to receive right at the beginning without the need to wait until deal matching and checkout process. The WYSIWYG interface makes it easier for users to create and edit their bids. Sale tax, service fee charged by the trading platform are all included in the calculation for the users automatically. Users know the exact final settlement amount of the deal without the need to further calculation, which enables an intuitive and immediate feedback loop between the bidding input and final settlement output stages.

The new trading system ensures that trades are executed fairly and accurately between multiple parties. Payments are made in a simple, timely and secure manner. The current invention has resolved those issues in the existing e-Commerce marketplace and the Commodity Trading system with currently available computer and internet technologies.

### SUMMARY OF THE INVENTION

The apparatus and methods disclosed herein reveal a trading system that can trade both merchandise and service. Any tradable/deliverable including both tangible goods and intangible services are traded between multiple parties including not only sellers and buyers, but also Carriers (when tangible goods are traded thus need to be physically transported from seller to buyer) is now actively participated in the trading and the deal matching process. The Invention compares all possible combinations of sellers, buyers and carriers, take all combinations of sellers' asking prices, buyers' bidding prices and carriers' shipping and handling costs for the route, plus any appliable tax, discount etc. into consideration, then calculate a final Gap/Spread price to match deals between multiple parties.

The Invention will enable all Parties (collectively represent the buyer, seller, and carrier involved in the trade) to compete actively and efficiently on the marketplace. At the very beginning of the process without waiting until the checkout, Buyers can know the final cost they will eventually pay, and Sellers and Carriers can know the final payment they will get. The exact payment or cost each party receives or pays at the end of the transaction is calculated automatically in real time and displayed to users when the parties bid at the very beginning of the deal matching. This “what you see is what you get” (WYSIWYG) capability is valuable to all parties. In the end, the buyer pays the bidding price, the seller receives the asking price payment, and the carrier receives the freight bid payment, broker gets the broker fee, and tax collector agent gets the tax payment. Each Party's portion that represents their share in the overall value distribution of the transaction will be displayed and acknowledged by all related parties throughout the entire bidding and deal matching process.

The invention will also enable the Parties (Buyer/Seller/Carrier) to monitor data such as number of competitors in the marketplace, previous trading volumes and each party's own portion of the “value distribution” or “value allocation” when a deal is matched and executed. The Parties can see the deal value distribution on the market in real time, not only the current market value, but also historical in the past.

Parties can utilize other trading tools like Stop Order, Limit Order, and options which are currently only available on the stock and future market, but not available to trade regular common merchandise and services.

### DETAILED DESCRIPTION OF THE INVENTION

All parties need to register with the system first and get their user ID, and then proceed to the next step to login and set a role as a Buyer, a Seller or as a Carrier. Same user ID can switch between different roles in different transactions. The Buyer in one deal can also be the Seller, or even a Carrier in another transaction. A Carrier offering delivery service in one deal can also bid on an item as Buyer in a different deal as well.

### Listing of Item and Service

Seller can list item for sale {2202}, Buyer can also list item to buy {2201}. Buyer and seller can both set the desired shipping service level {2204, 2205} they want to use to for shipping the merchandise from seller to buyer after deal is matched. As long as there are no matched deals, both the seller and buyer have the freedom to create, modify, or cancel their listings of items, or the required shipping service level at any time.

Shipping carriers {301} can list shipping services {2203} that provides many service levels and package options to meet different shipping needs. As long as there are no matched deals, Carriers have the freedom to create, modify, or cancel their listings.

### Bidding

Buyers and Sellers can browse through the existing listed items on the market and place Bidding Price and Asking Price on the items if they are interested. Carriers can browse through the list of all required shipping services on the marketplace and, either post freight tariff table {302, 2010} in batches, or place a freight bid on one individual shipping service if they are interested. Carrier can do this by posting a tariff lookup table {302} after logged in {2010}. The tariff table includes Freight Bid associated with various package options, delivery service level options, and all possible combinations of different sellers' origins and buyers' destination's locations {104} available in the market. The tariff table provided by shipping carriers can be as general as a flat fee for all packages, or for between certain shipping zones, or as detailed as the shipping cost between different zip codes, or even street address combinations (this is like a Uber driver act as Carrier happen to go one route at a certain time window, and can take a small extra step to deliver packages for that route at the same time). This tariff table allows both the carriers as well as buyer and sellers to have a clear understanding of the shipping costs and options available for meeting different shipping needs.

### Generation of Deal Candidate List

As an example, assuming the total number of Sellers on the marketplace selling one item (either a Merchandise or Service) is N_{A}, and the total of Buyers on the marketplace buying the same item is N_{B}. There would be in total N_{A}*N_{B} combinations of Buyer-Seller Pairs {201}. Further assuming the total number of Carriers on the marketplace that can offer shipping service for shipping the item from Sellers to Buyers is N_{C}. This results in a total of N_{A}*N_{B}*N_{C} combinations of Buyer-Seller-Carrier Consortium {401}. These Buyer-Seller-Carrier Consortium can be filtered to make the Deal Candidate List {2216} where all Buyers' bidding price, all sellers' asking price and all Carriers' shipping freight bids are used for further process to get matched deals. Various filtering methods can be applied on the Consortiums prior to making the Candidate List to reduce the total count of the Candidate List {2216}. A Pre-matching of Buyers and Sellers' requirements on their counterparties {2206, 2208} can make less the Seller-Buyer Pairs. Pre-matching of the shipping package and service level to use between the Buyer and Seller also created the competition domain of matched shipping services {2212} where different carriers will place their Freight Bid. Pre-Matching also ensures all consortium added to the Deal Candidates List are qualified and ready for further Gap calculation and deal matching

### Multiparties Gap Price/Spread Calculation and Deal Matching

Trading tangible merchandise is totally different than trading intangible stocks because at the end of the transactions, delivery are required to physically transfer the underlying products from seller to the buyer, and a carrier is needed as a third-party of the deal. Traditional e-commerce handle this by having either the buyer, or the seller to take the responsibility to choose a shipping carrier, where the carrier selected is passively involved in the deal matching process, as the carrier cannot make decision of whether or not to provide the shipping service and at what cost.

In the current invention, a multiparty deal matching method is used {2217}. The Multiparty Gap Price (Spread) is defined as:

$$Gap = Bidding Price - Asking Price - Freight Bid$$

The new formula not only includes the seller and the buyer, but also the carrier. This enables the carrier to actively and interactively participate in the entire deal matching process by offering and modifying their shipping service freight cost independently in real time. Carriers can add, modify, or cancel their offer of shipping service at any time, and any change in Freight bid will immediately change the Gap/Spread on the marketplace. This enables Carriers to play the same important role as the Buyers and Sellers.

More stakeholders can be included in the Gap/Spread calculation formula. For example, the definition of Gap/Spread can be changed as:

$$Gap = Bidding Price - Asking Price - Freight Bid - Sale Tax - Insurance + Promotion$$

where any changes in the tax rate (like in a tax-free day) or insurance cost, the marketplace will be affected at once. This formula also shows that the insurance cost is in the Gap calculation formula, so insurance companies can directly compete in the marketplace now just like Carrier.

Furthermore, different weights can be applied as coefficients to calculate the weighted Gap/Spread using formula:

$${Gap}_{weighted} = {w}_{1} \times Bidding Price - {w}_{2} \times Asking Price - {w}_{3} \times Freight Bid - … - {w}_{n} \times {Fee}_{n}$$

This weighted Gap may produce a different rank value than using the regular standard Gap formula, where all the weight coefficients are set to 1.

Orders' execution priority rank can follow the common “price-time priority” rule. The rank of order execution is first set according to the Gap Prices/Spread (standard Gap or weighted Gap). When multiple orders have the same Gap price, the order execution priority is then determined based on the time at which the Deal Candidate offers were placed by the Buyers, Sellers and Carriers. For an example in FIG. 4 dc_25 and dc_22 have the same Gap price $3.89 {402}, but because Seller A4 of dc_25 placed the sell offer earlier (on Feb. 1, 2023) than Seller A3 in dc_22 (on Feb. 8, 2023), dc_25 got a higher rank than dc_22 and will be matched first, even though they both have the same Gap value {501}.

Some non-fee criteria can further be quantified and included in the Gap/Spread calculation formula. For example, we will quantify the counter parties' rating in the calculation by formula:

$${Gap}_{new} = Gap + Buyer Rating + Seller Rating$$

This will make a Deal Candidate's rank higher if the Buyer and Seller have higher rating. The trading platform will execute their deals first even if the Gap value calculated from fees are same as other Deal Candidates.

Different trading platforms can compete with each other by applying different Gap calculation formulas and applying different order priority rank setting rules to the Deal Candidate List. The trade platforms may choose their own methods and algorithms other than the “price-time priority” rule to calculate the order's execution rank then set the order execution priority. For example, platform can set a “price-user-rating priority” rule, where order from a user who has better rating get higher rank and executed first; or, a “price-recyclable-packing priority” rule, where an order from a Carrier who use recyclable shipping package material will get higher rank and executed first; a “price-SBA priority” rule, where order from a user who is a minority owned small business get higher rank and executed first. When different rules are used, the rank value will be different, thus deals in the Deal Candidates List will be executed in different orders.

Deal Candidates with higher rank will be executed before lower ranked Deal Candidates. After a higher ranked Deal Candidates are matched and executed, the quantity to buy and the quantity to sell of the lower ranked Deal Candidates that involving the same Buyer or Seller as the just matched Deal, will be reduced by the same quantity as in the deal just matched. If either the remaining quantity to buy or the quantity to sell is less or equal to zero, then that Deal Candidate is considered fulfilled and removed from the list. This process continues until no Deal Candidates on the list has a Gap value greater than zero.

Deal Candidates with negative Gap Prices/Spread {502} cannot generate any matched deals and will remain on the marketplace. Any market changes such as a buyer increased his Bidding Price, or a seller reduced his Asking Price, or a carrier reduced his Freight Bid will all make the Gap Price/Spread getting closer to Zero, if the combination of those changes has made a Deal Candidate's Gap Price become greater than or equal to zero, a new deal can then be matched.

### Market Price

For any given buyer, there is a unique marketplace for the merchandise that he wants to buy, created by combining all the sellers of the item with all the carriers who offer shipping services for the routes from those sellers to the buyer. For each iteration of the Seller-Carrier pair, the total cost to Buyer is the seller's Asking Prices plus the Carrier's Freight Bid. The lowest value obtained from iterating over all Seller-Carrier pairs, where the value for each pair is calculated as the sum of the Seller's asking price and the Carrier's Freight Bidis, is the Market Price of the item to this Buyer (MP_{Buyer}) {1403, 1404}:

$${MP}_{Buyer} = Min ( Asking Price + Freight Bid )$$

It is the best deal he can get on the marketplace, which means the best among all Seller/Carrier pair combinations that has the highest Gap/Spread {1402}.

For buyers of item #888, the offers (sum of Asking Price+Freight Bid) on the market to Buyer B1 range from $6.20 to #11.02 {1401}, these reflect the cost Buyer will have to pay if he wants to buy item #888 from the marketplace from different sellers and deliver by different carriers. The lowest of all is $6.20 and this is the current market price of this item #888 to Buyer B1. This price is higher than the $5.50 that B1 currently bids at by $0.70 {1402}, so Buyer B1 cannot make any deal at current market conditions.

The range of offers to Buyer B2 and other Buyers are different than those to Buyer B1 due to the different seller's price and carriers' freight combinations. The market prices for the same item #888 to other Buyers are different from that to B1. We can see from FIG. 14 that the market prices are $7.11 to Buyer B2, $8.08 to B3 and B4 {1403, 1404}. Deal Candidates where the cost to Buyer equals to these market prices are listed as {1404}

From the perspective of parties other than the Buyers, the same marketplace will appear different. For a Seller, the market price will be the difference between the Buyer's Bids and the Carriers' Freight Bid. It reflects how much payment money can be allocated to seller after portion of buyer's bid is used to pay carriers' freight. To any Seller, the total payment he can receive equals to the Buyer's bidding price minus the Carrier' Freight Bid {1501}. The Market Price for a Seller (MP_{Seller}) is the highest value obtained from iterating over all Buyer-Carrier pairs, where the value for each pair is calculated as the difference between the Buyer's Bidding Price and the Carrier's Freight Bid:

$${MP}_{Seller} = Max ( Bidding Price - Freight Bid )$$

It represents the best deal the Seller can get on the marketplace, which means the best among all Buyer/Carrier combinations that has the highest Gap/Spread {1502}. This Buyer/Carrier pair combination also offers the highest payment amount to Seller. {1503, 1504}.

Carriers are competing on the shipping service via different routes to deliver the package for a traded item, and not on the item itself like the Buyer and Seller do. Carriers can compete on all routes and usually without any quantity restrictions like the Buyer and Seller does. For example, All Buyer-Seller pairs have their corresponding routes {801, 1601}, and different routes will have different freight cost. Other than the routes, the Market Price is also related to the package being shipped and service level as well, because Freight is a function that has multiple variables.

To a carrier {1603, 1606}, each of the Buyer-Seller pair is also a route-package-service level combination. route-package-service level combination may correspond to multiple Buyer-Seller pairs who ship the same type of package via the same route using save service. The same type of package may be used to hold different items. One Market Price exist on each of these route-package-service level combination (as a sub-market) and it equals to the highest value obtained from iterating over all Buyer-Seller pairs, where the value for each combination is calculated as the difference between the Bidding Price and the Asking Price. FIG. 17 shows carriers compete on all the routes on the market instead of just picking one best route with highest spread. In this case, the marketplace to the carrier is then divided into many sub-markets, each identified by different routes, package and service level. And there is a Market Price (MP_{Carrier}) for each of those sub-marketplaces {1702}:

$${MP}_{Carrier} = Max ( Bidding Price - Asking Price ) .$$

The Market Price for the entire marketplace (combines all sub-markets regardless of what routes-package combination) is the best deal the carrier can get on the entire marketplace among all Buyer-Seller (route-package) combinations that offers the highest Gap/Spread {1602} and thus has the highest rank. The Buyer-Seller pair combination with the highest Gap/Spread {1602} is not necessarily always where Carrier will get the highest total payment amount (Buyers' bidding price minus Sellers' asking price) {1605}. This is because different routes will have different costs to the carriers as well. The actual best deal for a carrier is reached when the Gap/Spread (the difference between the payment that carrier received and the carrier's cost) are maximum {1606}.

FIG. 16's and FIG. 17 example shows a simplified market of only one item been traded and one package type and one service level. But in the real world, millions of items are traded at the same time on the marketplace. And different items may use the same type of package, save service level and via the same route. for example, a large foam padded envelope overnight from Boston to NYC can be used by different deal candidates from transactions on totally different traded items. Carriers are competing in a different package transportation domain of the marketplace, which is not the item domain like the buyer and seller do, even the two domains are closely related (items defines the package used, and buyer and seller's decide on service level to use, and their locations define the route).

When all Deal Candidates with positive Gap Prices have been matched and executed, Deal Candidate with negative Spread will remain on the marketplace and waiting for market conditions to change before any new deals can be made. Spread can provide information about the supply and demand for an item. Spread is a useful indicator for evaluating volatility, liquidity, trading costs, and market conditions. Trading parties can use it to understand market volatility or other uncertainty. For example, the Spread may widen when trading volume is reduced or transaction costs (such as the service fee charged by the trading platform) is increased. Any market participants adjusting their Bidding Price, Asking Price or Freight Bid will affect the Spread. By monitoring the Spread, the user can know the liquidity, or, how easy or difficult it may be to buy or sell that item at a given time. For example in FIG. 13, after all deals with positive Gap are matched, those Deal Candidate list from dc_14 (B1/A5/C2) to dc_01 (B1/A1/C3) will remain on the market place with Spread values ranging from $0.70 to $5.22 {1303, 1304}. If the market condition changes by either Buyer B1 increases Bidding Price by $0.70, Seller A5 reduce Asking Price by $0.70 or Carrier C2 reduced its Freight Bid by $0.70, it will bring the Spread of dc_14 to zero and a new deal will be made on this B1-A5-C2 combination.

There are many ways that the market condition can be changed, such as existing parties on the marketplace modifying their existing bids, or new players entering the marketplace, or the trading platform changed the service fee or tax rate changed, or some special promotion discount happens during holidays.

### Historical Data and Market Analitical Charts

When a user logs in the trading platform and chose an item, he can see interfaces illustrated where he acts like a Buyer (FIG. 18), a Seller (FIG. 19) or a Carrier (FIG. 20). The user can switch between different roles under the same user ID, such as buy item A as a buyer and sell item B as a seller, but under the same user ID.

For example, a buyer searches for an item to buy {1801}, then the item's specification and photos are displayed {1802}. The item's current market price and Spread are displayed in real time, and its historical price data, as well as other indicators such as trading volume, open and closing price, high price and low price via Bar Chart or Candlestick chart {1803}. As we have mentioned earlier, different users will have different market prices even for the same item, thus different historical data and different charts will be displayed for each individual user.

The numerous methods and indicators used in the stock market analysis (both fundamental analysis and technical analysis) can be used on the trading platform as well, such as Moving Averages, Moving Average Convergence Divergence, Bollinger Bands, Stochastic Oscillator, etc. Users can access these advance data {1804} to help their decision making.

### Prediction and Trade Assistant

Trading parties can modify their own bids any time before a deal is matched and executed. For example, Buyer B1 wants to buy 3 items. On the marketplace, there are four sellers selling the item and there are three carriers service and complete on the delivery route from those sellers to B1 {1304}. The current Spread of the market is ranging from $0.70 to $5.22.

The trading platform will provide prediction feedback to Buyer B1 and tell him what deal can be made at different Bidding Price levels. If B1 increases its bid by $0.70 to $6.20 which is the Market Price, he can get one item. In case Buyer B1 needs to get all three of them, then he will increase his bid at least by $2.54 to $8.04. Buyer B1 can observe how changes in his Bidding Price will result in winning different quantities of the item during his bidding process dynamically {1811} and make well informed decisions before he places an order.

### Distribution of Gap/Spread Values

At the opening of the market, or during periods of high volatility, there may be instances where Deal Candidates have a Gap Price greater than zero. For example, in dc_25, the Gap Price is $3.89 {601}. This Gap or Spread can be distributed among the associated Buyer B2, Seller A4, and Carrier C3 of this Deal Candidate record. Once the distribution is complete, the buyer can acquire the product at a price lower than their original bidding price, the seller will receive more than their asking price, and the carrier will also receive more than their freight bidding. Other stakeholders, such as the trading platform and brokers, can also benefit from this Spread-Sharing mechanism.

### Order Execution, Settlement and Escrow

After the deals between the Buyer, Seller, and Carrier have been matched, the trade will be executed in the order of rank at the agreed-upon price, quantity, and shipping service level. A trade confirmation will be generated and sent to the Buyer, Seller, and Carrier, which will provide details about the price, quantity, package information, pick-up or drop-off information, tax rate, and other relevant information regarding the deal.

The winning buyer then makes payment through the platform's secure payment system. The funds are distributed to the winning seller, winning carrier, and to other stakeholders such as the trading platform for their service fee, the brokers for their broker fees, insurance companies for the insurance, and to sales tax collector agent, etc. An escrow account may also be used to hold funds until a later time, to be released to Seller and Carrier. This can prevent fraud, resolve quality and quantity dispute issues, thus protecting the Parties of the deal.

### Physical Delivery

Once the payment is confirmed and funds distribution is complete, if the traded item is a tangible good that requires physical delivery from the winning seller to the winning buyer, the winning carrier will arrange for transportation and storage of the goods. Tracking information will be generated and sent to relevant parties and stakeholders, according to the service level requirements of the deal, to ensure traceability and a smooth delivery process.

### User Feedback, System Statistics and Rating

At the end of the deal execution, feedback will be collected from all parties of the deal on the item traded, the shipping service used, and on their counter parties. The trading platform can also generate system statistics such as payment speed of the buyer, delivery on time ratio of the carriers, etc. All these information can be used as rating criterial for future deal matching.

### Alternative Embodiment

Current invention provides a new trading infrastructure where users can trade a wide range of common merchandise like trading stocks. They can do a one-click deal match by placing a Market Order just like on the stock market, the system then makes a deal at the best possible price available at that specific time.

As an alternative, users can use other various order types, like the Limit Order, Stop Order, Stop-Limit Order, and to set the order conditions as Good-Till-Cancel, All-or-None, Fill-or-Kill, etc. . . .

Furthermore, those order types typically associated with options and futures markets can now be employed for trading regular merchandise too. These encompass Put and Call Orders, Market-if-touched (MIT) orders, Market-on-close (MOC) orders, Market-on-open (MOO) orders, Contingent orders, One-cancels-the-other (OCO) orders, and more.

What is claimed is:

1. A computer-implemented method for trading merchandise and service, comprising:
enabling sellers to list items for sale and buyers to list items to buy, along with defining their desired shipping service levels;
enabling shipping carriers to list shipping service to provide, shipping package specifications and route information;
allowing sellers, buyers, and shipping carriers to modify or cancel their listings at any time if there is no matched deal at that moment;
facilitating buyers and sellers to browse and search items they are interested in, and place bidding price and asking price;
facilitating carriers to browse and search shipping services they are interested to provide, and place freight bid;
allowing Buyers, Sellers, and Carriers to modify or cancel their bids if there is no matched deal at that moment;
allowing Buyers, Sellers, and Carriers to set requirement for the counterparties that they want to deal with;
allowing buyer and sellers to bundle Items and consolidating services for bidding by adding items or services to cart or bundle, then placing bid on the entire cart or bundle as a whole;
allowing carriers to consolidating shipping services for placing freight bid by consolidating multiple packages on the same route or merging several routes into a multileg shipping service, then placing freight bid on the entire consolidated shipping service as a whole;
allowing buyers to monitor the current and historical market price as well as price trend in the marketplace, where the Market Price for buyer (MP_{Buyer}) is defined as the lowest value obtained from iterating over all Seller-Carrier pairs by summarizing the Seller's Asking Price and the Carrier's Freight Bid: MP_{Buyer}=Min(Asking Price+Freight Bid);
allowing sellers to monitor the current and historical market price as well as price trend in the marketplace, where the Market Price for seller (MP_{Seller}) is defined as the highest value obtained from iterating over all Buyer-Carrier pairs by deducting the Carrier's Freight Bid from the Buyer's Bidding Price: MP_{Seller}=Max(Bidding Price−Freight Bid);
allowing carriers to monitor the current and historical market price as well as price trend in the marketplace, where the Market Price for carrier (MP_{Carrier}) is defined as the highest value obtained from iterating over all Buyer-Seller pairs by deducting the Seller's Asking Price from the Buyer's Bidding Price: MP_{Carrier}=Max(Bidding Price−Asking Price);
allowing buyers, sellers and carriers to predict and evaluate the impacts of changes in their bids on the total count of matched deals and the total quantity of traded items or services;
pre-matching buyer-seller pairs and buyer-seller-carrier consortiums, before adding them into the candidate list, based on criteria other than their bids including user rating, pay terms, shipping package, shipping service level and return policies; generating a deal candidate list consisting of only the pre-matched Seller-Buyer-Carrier Consortium and ensure all Deal Candidates in the list are qualified and ready for Gap calculation and deal matching;
calculating spread/gap prices based on buyer's bidding price, seller's asking price, and carrier's freight bid with formula:
$$Gap = Bidding Price - Asking Price - Freight Bid ;$$
sorting Candidate List by Gap, applying the price-time priority rule when Deal Candidates having the same Gap Price, then rank each buyer-seller-carrier Consortium in the Deal Candidate List;
matching and executing deals start from higher ranked Deal Candidate then the lower ranked ones, and following each execution, reducing the quantity to buy and the quantity to sell of all the lower ranked Deal Candidates that having the same Buyer or same Seller as in the just matched Deal, by the same quantity of the deal just executed, then mark the Deal Candidate as fulfilled and remove it from the Deal Candidate list if either the remaining quantity to buy or the remaining quantity to sell is less than or equal to zero;
continuing the deal match and execution process until no Deal Candidates on the list has a Gap value greater than zero, and keep all these unmatched Deals Candidates with negative spreads queued on marketplace until new matched deals are found or the offer been cancelled by any party of the deal candidate;
closing the deal and sending confirmation to all parties of the Deal Candidate, detailing relevant trade information about the executed deal's price, quantity, pay term, return policy, and shipping service level if the traded item is tangible merchandise;
settling payment by having the winning Buyer make payment through the platform's secure payment system, then distributed to the winning Seller, winner Carrier, and other stakeholders such as to the trading platform for their service fee, to brokers for their broker fees, to insurance company for the insurance, to sales tax collector agent for tax due, etc;
arranging shipping and providing tracking information once the payment is confirmed and fund distribution settlement is completed;
collecting feedback and ratings from all the parties of the deal on the traded item, the shipping service used for delivery, and their counterparties;
generating system statistics of the users trading history and deal performance data for future rating;
and providing a What You See Is What You Get (WYSIWYG) user interface for users to monitor the final cost or payment, the market price, and the impact of adjusting their bids.

2. The method of claim 1, further comprising:
the process to include a service fee charged by the marketplace website for facilitating the transaction between Buyer, Seller and Carrier. Other miscellaneous fees from other stakeholders such as sales tax, broker fee, insurance, sale discount can also be included in this process and be reflected in calculating the Spread/Gap Price value of each of the Deal Candidate List (Buyer-Seller-Carrier Consortium) with following formula:
Gap=Bidding Price−Asking Price−Freight Bid−Broker Fee−Marketplace fee−Insurance−Tax+MISC Discounts.

3. The method of claim 2, wherein the calculation of Spread/Gap includes all stakeholders' fees in the calculation formula, and further assigns varying weights coefficients to each stakeholder's fee with following formula:
$${Gap}_{weighted} = {w}_{1} \times Bidding Price - {w}_{2} \times Asking Price - {w}_{3} \times Freight Bid - … - {w}_{n} \times {Fee}_{n} .$$

4. The method of claim 3, wherein the weights of different fees are subjective and arbitrary, and the weights coefficients setting can be set and adjusted by both the marketplace (as default weights or as different profile), by a third-party API, or by each individual user (user's customized preference) according to his own preference on how to calculate the Spread/Gap, and this variety of weights coefficient setting makes the marketplace unique to each user is and makes the overall trading platform's ecosystem more diversified.

5. The method of claim 1, further comprising:
the process to include and quantify non-fee features (such as counterparty's rating) and include them to the Spread/Gap calculation with formula:
$$New Gap = Gap + Buyer ’ s Rating + Seller ’ s Rating + Quantified Non - Fee Criteria .$$

6. The method of claim 1, wherein rules other than “price-time priority” can be used, for example, a “Country of Origin rule” can give product from certain origination higher priority, a “User Rating-Price rule” may give higher ranks to users with good rating even their offer price might not be the best. The rule chosen will change the Consortium's rank in the Deal Candidate List, thus affecting the result of the final deals matched and their execution orders, and this variety of rules setting makes the marketplace unique to each user and makes the overall trading platform's ecosystem more diversified.

7. The method of claim 1, further comprising:
the process that allows the order types typically associated with options and futures markets to be utilized for trading regular merchandise. These encompass Put and Call Orders, Market-if-touched (MIT) orders, Market-on-close (MOC) orders, Market-on-open (MOO) orders, Contingent orders, One-cancels-the-other (OCO) orders, and more.

8. The method of claim 7, further comprising:
the process to create other financial instruments and derivatives and trade them on the marketplace.

9. The method of claim 1, further comprising:
the process to use an escrow account during the Payment and Settlement to hold the funds until a later time before release to the Seller and Carrier. This can prevent fraud, resolve quality and quantity dispute issues, thus protecting the parties of the deal.

10. The method of claim 1, further comprising:
cleaning up. If there is no active Asking price or Bidding price on a Listed Item or Service, and there is no previous trading history on them, then the system can De-List them by removing them from database.

11. The method of claim 1, wherein Buyer, Seller and Carrier can be grouped together and interact with each other as Grouped Buyer, Grouped Seller, and Grouped Carrier.

12. The method of claim 1, wherein the item on the marketplace can be grouped together as Grouped Item. The process can be done by using the item's UPC barcode and other unique identifiers.

13. A system for trading merchandise and service, the system comprising:
database to store data; a What You See Is What You Get (WYSIWYG) user interface allowing users to monitor the final cost and payment, market price upfront; and computer programs (rules, protocols, functions) to process data that can:
performing user registration and allowing registered users to switch roles between buyer, seller, carrier or other roles such as broker or agent under the same user ID without logging out;
enabling sellers to list items for sale and buyers to list items to buy, along with defining their desired shipping service levels;
enabling shipping carriers to list shipping service to provide, shipping package specifications and route information;
allowing sellers, buyers, and shipping carriers to modify or cancel their listings at any time if there is no matched deal at that moment;
facilitating buyers and sellers to browse and search items they are interested in, and place bidding price and asking price;
facilitating carriers to browse and search shipping services they are interested to provide, and place freight bid;
allowing Buyers, Sellers, and Carriers to modify or cancel their bids if there is no matched deal at that moment;
allowing Buyers, Sellers, and Carriers to set requirement for the counterparties that they want to deal with;
allowing buyer and sellers to bundle Items and consolidating services for bidding by add items or services to cart or bundle, then place bid on the entire cart or bundle as a whole;
allowing carriers to consolidating shipping services for placing freight bid by consolidate multiple packages on the same route or merge several routes into a multileg shipping service, then place freight bid on the entire consolidated shipping service as a whole;
allowing buyers to monitor the current and historical market price as well as price trend in the marketplace, where the Market Price for buyer (MP_{Buyer}) is defined as the lowest value obtained from iterating over all Seller-Carrier pairs by summarizing the Seller's Asking Price and the Carrier's Freight Bid: MP_{Buyer}=Min(Asking Price+Freight Bid);
allowing sellers to monitor the current and historical market price as well as price trend in the marketplace, where the Market Price for seller (MP_{Seller}) is defined as the highest value obtained from iterating over all Buyer-Carrier pairs by deducting the Carrier's Freight Bid from the Buyer's Bidding Price: MP_{Seller}=Max(Bidding Price-Freight Bid);
allowing carriers to monitor the current and historical market price as well as price trend in the marketplace, where the Market Price for carrier (MP_{Carrier}) is defined as the highest value obtained from iterating over all Buyer-Seller pairs by deducting the Seller's Asking Price from the Buyer's Bidding Price: MP_{Carrier}=Max(Bidding Price−Asking Price);
allowing buyers, sellers and carriers to predict and evaluate the impacts of changes in their bids on the total count of matched deals and the total quantity of traded items or services;
pre-matching buyer-seller pairs and buyer-seller-carrier consortiums, before adding them into the candidate list, based on criteria other than their bids including user rating, pay terms, shipping package, shipping service level and return policies;
generating a deal candidate list consisting of only the pre-matched Seller-Buyer-Carrier Consortium and ensure all Deal Candidates in the list are qualified and ready for Gap calculation and deal matching;
calculating spread/gap prices based on buyer's bidding price, seller's asking price, and carrier's freight bid with formula: Gap=Bidding Price−Asking Price−Freight Bid;
sorting Candidate List by Gap, applying the price-time priority rule when Deal Candidates having the same Gap Price, then rank each buyer-seller-carrier Consortium in the Deal Candidate List;
matching and executing deals start from higher ranked Deal Candidate then the lower ranked ones, and following each execution, reducing the quantity to buy and the quantity to sell of all the lower ranked Deal Candidates that having the same Buyer or same Seller as in the just matched Deal, by the same quantity of the deal just executed, then mark the Deal Candidate as fulfilled and remove it from the Deal Candidate list if either the remaining quantity to buy or the remaining quantity to sell is less than or equal to zero;
continuing the deal match and execution process until no Deal Candidates on the list has a Gap value greater than zero, and keep all these unmatched Deals Candidates with negative spreads queued on marketplace until new matched deals are found or the offer been cancelled by any party of the Deal Candidate;
closing the deal and sending confirmation to all parties of the Deal Candidate, detailing relevant trade information about the executed deal's price, quantity, pay term, return policy, and shipping service level if the traded item is tangible merchandise;
settling payment by having the winning Buyer make payment through the platform's secure payment system, then distributed to the winning Seller, winner Carrier, and other stakeholders such as to the trading platform for their service fee, to brokers for their broker fees, to insurance company for the insurance, to sales tax collector agent for tax due, etc;
arranging shipping and providing tracking information once the payment is confirmed and fund distribution settlement is completed;
collecting feedback and ratings from all the parties of the deal on the traded item, the shipping service used for delivery, and on their counterparties;
generating system statistics of the users trading history and deal performance data to be used for future rating;
storing all data related to user, items, service, all prices, transaction history, analysis results, payment and tracking information, feedback ratings, etc. to the database locally or on the cloud, where the data includes those of both matched deals and unmatched deal candidates;
and providing a What You See Is What You Get (WYSIWYG) user interface for users to monitor the final cost or payment, the market price, and the impact of adjusting their bids.

14. The system of claim 13, wherein the computer programs further comprising a process to include service fee charged by the marketplace platform to the Gap/Spread calculation formula for facilitating the transaction, while miscellaneous fees from other stakeholders such as insurance cost, broker fee, taxes, discount and promotion can all be included when calculating the final Spread/Gap in following formula:
$$Gap = Bidding Price - Asking Price - Freight Bid - Broker Fee - Marketplace fee - Insurance - Tax + MISC Discounts .$$

15. The system of claim 14, wherein the calculation of the Spread/Gap includes all stakeholders' fees in the calculation formula, and further assign varying weights coefficients to each stakeholder's fee with following formula:
$${Gap}_{weighted} = {w}_{1} \times Bidding Price - {w}_{2} \times Asking Price - {w}_{3} \times Freight Bid - … - {w}_{n} \times {Fee}_{n} .$$

16. The system of claim 15, wherein the weights coefficients of different fees are subjective and arbitrary, and the weight coefficients can be set and adjusted by both the marketplace (as default weights value or different profile), by a third-party API, or by each individual user (user's customized preference) according to his own preference on how to calculate the Spread/Gap.

17. The system of claim 13, wherein the computer programs further comprising a process to quantify non-fee features such as the counterparty's rating then include them to Spread/Gap calculation with formula:
$$New Gap = Gap + Buyer ’ s Rating + Seller ’ s Rating + Quantified Non - Fee Criteria .$$

18. The system of claim 13, wherein rules other than “price-time priority” can be used.

19. The system of claim 13, wherein the computer program can employ the order types which are typically associated with options and futures markets to trade regular merchandise. These encompass Put Options and Call Options, Market-if-touched (MIT) orders, Market-on-close (MOC) orders, Market-on-open (MOO) orders, Contingent orders, One-cancels-the-other (OCO) orders, and more.

20. The system of claim 19, wherein the computer program can employ other financial instruments and derivatives, and trade them on the marketplace.

21. The system of claim 13, wherein the computer programs performing Payment and Settlement function further comprising the process to use an escrow account to hold funds until a later time before releasing to the Seller and Carrier. This can prevent fraud, resolve quality and quantity dispute issues and protect the Parties of the deal.

22. The system of claim 13, wherein the computer program further can perform self-cleaning to delete unusual data or errors.

23. The system of claim 13, wherein the computer program can group Buyers, Sellers, and Carriers on the marketplace, and generate candidates and match deals between grouped Buyers, Grouped Sellers and Grouped Carriers.

24. The system of claim 13, wherein the computer program can group items on the marketplace and trade them as Grouped Item. The process can be done by using the item's UPC barcode and other unique identifiers.

25. The system of claim 13, further comprising Application Programming Interface (API) and computer program (rules, protocols, functions) to allow the system to communicate with other computers and servers to exchange data with third parties.
The system of claim 13 wherein the computer program is integrated as firmware into a chip and physically constructed as part of the merchandise's PCB/PCBA. This can enable the merchandise to be listed and traded by its owner as easily as pushing one single button on the merchandise without logging in to the trading marketplace website.
